(19) United States
(12) Patent Application Publication
(10) Pub. No.: US 2008/0062252 A1
(43) Pub. Date: Mar. 13, 2008

(54) Apparatus and method for video mixing and computer readable medium

(75) Inventors: Takuya Kawamura, Kawasaki-Shi (JP); Naohisa Shibuya, Kawasaki-Shi (JP); Nobuhiko Sugasawa, Kawasaki-Shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/896,852

(22) Filed: Sep. 6, 2007

(30) Foreign Application Priority Data
Sep. 8, 2006 (JP) 2006-244553

(51) Int. Cl. H04N 7/15

(52) U.S. Cl. 348/14.09; 348/E07.084

(57) ABSTRACT

There is provided with a video mixing method including: receiving first to third video data expressing first to third videos from first to third terminals; mixing the first to third video data to generate first to third mixed video data; transmitting the first to third mixed video data to the first to third terminals; receiving first to third voice data expressing first to third voices from the first to third terminals; mixing the first to third voice data to generate first to third mixed voice data; transmitting the first to third mixed voice data to the first to third terminals; and increasing a voice level of the second voice to be included in the first mixed voice and a voice level of the first voice to be included in the second mixed voice upon receiving video selection information indicating that the second video has been selected from the first terminal.

### CROSS-REFERENCE TO RELATED APPLICATIONS

This application is based upon and claims the benefit of priority from the prior Japanese Patent Applications No. 2006-244553 filed on Sep. 8, 2006, the entire contents of which are incorporated herein by reference.

### BACKGROUND OF THE INVENTION

1. Field of the Invention

The present invention relates to a video mixer (multipoint control unit) which delivers a mixed video and a mixed voice to a plurality of networked terminal devices, a method of controlling the mixed video and the mixed voice delivered by the video mixer and a computer readable medium.

2. Related Art

A method of realizing a privacy communication using a multipoint control unit (MCU) is proposed (JP-A No. 10-224485 (Kokai)). When a terminal transmits a video and voice to the MCU, the terminal transmits a privacy identification signal indicating with which party to conduct a privacy communication. The MCU side inputs received information to a video mixing unit, a voice mixing unit and a data mixing unit (privacy identification signal mixing) and delivers a mixed video, a mixed voice and a mixed privacy identification signal to each terminal. Each terminal receives the mixed video, mixed voice and mixed privacy identification signal, analyzes the mixed privacy identification signal and as a result if the own terminal is the privacy communication target, the terminal reproduces the video and voice. If not the target, reproduction of the video and voice is stopped.

In an actual conference, local conversations (private conversations) such as private consultation and confirmation are often conducted during the conference. In an actual conference, while engaging a local conversation, a party concerned often holds a conversation in a small voice with the other party so that other people in the conference do not hear the voice. That is, the parties come close to each other and talk in suppressed tone of voice. On the other hand, other conferees recognize that a local conversation is being held, may cause the local conversation to stop or may also participate in the local conversation depending on their needs.

### SUMMARY OF THE INVENTION

According to an aspect of the present invention, there is provided with a video mixer comprising:

a video reception unit configured to receive first to third video data expressing first to third videos from first to third terminals;

a video mixing unit configured to mix the first to third video data to generate first to third mixed video data expressing first to third mixed videos;

a video transmission unit configured to transmit the first to third mixed video data to the first to third terminals;

a voice reception unit configured to receive first to third voice data expressing first to third voices from the first to third terminals;

a voice mixing unit configured to mix the first to third voice data to generate first to third mixed voice data expressing first to third mixed voices;

a voice transmission unit configured to transmit the first to third mixed voice data to the first to third terminals;

a video selection information receiver configured to receive video selection information indicating that the second video is selected from the first terminal; and

a voice control unit configured to generate a voice mixing control signal which gives an instruction to increase a voice level of the second voice to be included in the first mixed voice and a voice level of the first voice to be included in the second mixed voice and give the voice mixing control signal to the voice mixing unit.

According to an aspect of the present invention, there is provided with a video mixer comprising:

a video reception unit configured to receive first to third video data expressing first to third videos from first to third terminals;

a video mixing unit configured to mix the first to third video data to generate first to third mixed video data expressing first to third mixed videos;

a video transmission unit configured to transmit the first to third mixed video data to the first to third terminals;

a voice reception unit configured to receive first to third voice data expressing first to third voices from the first to third terminals;

a voice mixing unit configured to mix the first to third voice data to generate first to third mixed voice data expressing first to third mixed voices;

a voice transmission unit configured to transmit the first to third mixed voice data to the first to third terminals;

a video selection information receiver configured to receive video selection information indicating that the second video has been selected from the first terminal; and

a mixed voice control unit configured to generate a voice mixing control signal which gives an instruction to reduce the voice levels of the first voice and the second voice to be included in the third mixed voice and give the voice mixing control signal to the voice mixing unit.

According to an aspect of the present invention, there is provided with a video mixer comprising:

a video reception unit configured to receive first to third video data expressing first to third videos from first to third terminals;

a video mixing unit configured to mix the first to third video data to generate first to third mixed video data expressing first to third mixed videos;

a video transmission unit configured to transmit the first to third mixed video data to the first to third terminals;

a voice reception unit configured to receive first to third voice data expressing first to third voices from the first to third terminals;

a voice mixing unit configured to mix the first to third voice data to generate first to third mixed voice data expressing first to third mixed voices;

a voice transmission unit configured to transmit the first to third mixed voice data to the first to third terminals;

a video selection information receiver configured to receive video selection information indicating that the second video has been selected from the first terminal; and

a mixed voice control unit configured to generate a voice mixing control signal which gives an instruction to reduce the voice level of the third voice to be included in the first mixed voice and the second mixed voice and give the voice mixing control signal to the voice mixing unit.

According to an aspect of the present invention, there is provided with a video mixing method comprising:

receiving first to third video data expressing first to third videos from first to third terminals;

mixing the first to third video data to generate first to third mixed video data expressing first to third mixed videos;

transmitting the first to third mixed video data to the first to third terminals;

receiving first to third voice data expressing first to third voices from the first to third terminals;

mixing the first to third voice data to generate first to third mixed voice data expressing first to third mixed voices;

transmitting the first to third mixed voice data to the first to third terminals; and

increasing a voice level of the second voice to be included in the first mixed voice and a voice level of the first voice to be included in the second mixed voice upon receiving video selection information indicating that the second video has been selected from the first terminal.

According to an aspect of the present invention, there is provided with a computer readable medium storing a computer program for causing a computer to execute instructions to perform steps of:

receiving first to third video data expressing first to third videos from first to third terminals;

mixing the first to third video data to generate first to third mixed video data expressing first to third mixed videos;

transmitting the first to third mixed video data to the first to third terminals;

receiving first to third voice data expressing first to third voices from the first to third terminals;

mixing the first to third voice data to generate first to third mixed voice data expressing first to third mixed voices;

transmitting the first to third mixed voice data to the first to third terminals;

receiving video selection information indicating that the second video has been selected from the first terminal; and

controlling voice mixing so as to increase a voice level of the second voice to be included in the first mixed voice and a voice level of the first voice to be included in the second mixed voice.

According to an aspect of the present invention, there is provided with a video mixer which can communicate with a voice mixer configured to mix first to third voice data expressing first to third voices transmitted from first to third terminals, generate first to third mixed voice data expressing first to third mixed voices and transmit the first to third mixed voice data generated to the first to third terminals, comprising:

a video reception unit configured to receive first to third video data expressing first to third videos from the first to third terminals;

a video mixing unit configured to mix the first to third video data to generate first to third mixed video data expressing first to third mixed videos;

a video transmission unit configured to transmit the first to third mixed video data to the first to third terminals;

a video selection information receiver configured to receive video selection information indicating that the second video has been selected from the first terminal; and

a voice control unit configured to generate a voice mixing control signal which gives an instruction to increase a voice level of the second voice to be included in the first mixed voice and a voice level of the first voice to be included in the second mixed voice and transmit the voice mixing control signal generated to the voice mixing unit.

### BRIEF DESCRIPTION OF THE DRAWINGS

FIG. 1 is a system configuration diagram of a video-conferencing system according to a first embodiment of the present invention;

FIG. 2 illustrates a situation in which a user operates each terminal of the video-conferencing system according to the first embodiment of the present invention;

FIG. 3 illustrates input videos, input voices, mixed videos and mixed voices at the start of the video-conferencing according to the first embodiment of the present invention;

FIG. 4 illustrates the size of a video and an average volume of voice according to the first embodiment of the present invention;

FIG. 5 illustrates a situation in which user A has conducted a layout change operation on a mixed video according to the first embodiment of the present invention;

FIG. 6 shows a first example of input videos, input voices, mixed videos and mixed voices when user A has conducted a layout change operation on a mixed video according to the first embodiment of the present invention;

FIG. 7 shows a second example of input videos, input voices, mixed videos and mixed voices when user A has conducted a layout change operation on a mixed video according to the first embodiment of the present invention;

FIG. 8 shows an example of the appearance of a conference terminal 21 according to the first embodiment of the present invention;

FIG. 9 shows an example of the system configuration of the conference terminal 21 according to the first embodiment of the present invention;

FIG. 10 shows an application program stored in a hard disk drive in the system configuration of the conference terminal 21 according to the first embodiment of the present invention;

FIG. 11 shows an example of the appearance of a multipoint control unit 1 according to the first embodiment of the present invention;

FIG. 12 shows an example of the system configuration of the multipoint control unit 1 according to the first embodiment of the present invention;

FIG. 13 shows an application program stored in the hard disk drive in the system configuration of the multipoint control unit 1 according to the first embodiment of the present invention;

FIG. 14 shows the internal configuration of the conference terminal 21 according to the first embodiment of the present invention;

FIG. 15 shows the internal configuration of a layout change instructor 300 according to the first embodiment of the present invention;

FIG. 16 shows an initialization condition of an area management table according to the first embodiment of the present invention;

FIG. 17 illustrates the position and the size of arrangement in a mixed video according to the first embodiment of the present invention;

FIG. 18 shows an example of the payload unit of a mixed video control packet according to the first embodiment of the present invention;

FIG. 19 shows a display screen 2100 of the conference terminal 21 according to the first embodiment of the present invention;

FIG. 20 shows an example of a state in which the area management table according to the first embodiment of the present invention is changed;

FIG. 21 shows the internal configuration of the multipoint control unit 1 according to the first embodiment of the present invention;

FIG. 22 shows an example of the internal configuration of the mixed video unit 11 according to the first embodiment of the present invention;

FIG. 23 shows an example of the internal configuration of the voice mixing unit 12 according to the first embodiment of the present invention;

FIG. 24 illustrates additional components to adjust the size of an input video and the volume of an input voice according to the first embodiment of the present invention;

FIG. 25 shows another example of the system configuration of the conference terminal 21 according to the first embodiment of the present invention;

FIG. 26 shows another example of the system configuration of the multipoint control unit 1 according to the first embodiment of the present invention;

FIG. 27 shows a situation in which user C has conducted a layout change operation on a mixed video according to a second embodiment of the present invention;

FIG. 28 shows a first example of input videos, input voices, mixed videos and mixed voices when user C has conducted a layout change operation on the mixed video according to the second embodiment of the present invention;

FIG. 29 shows a second example of input videos, input voices, mixed videos and mixed voices when user C has conducted a layout change operation on the mixed video according to the second embodiment of the present invention;

FIG. 30 shows another example of the system configuration of the video-conferencing system according to the first embodiment or the second embodiment of the present invention;

FIG. 31 is a flow chart illustrating processing procedure example 1 in the layout change instruction analyzer 13 according to the first embodiment of the present invention; and

FIG. 32 is a flow chart illustrating processing procedure example 2 in the layout change instruction analyzer 13 according to the first embodiment of the present invention.

### DETAILED DESCRIPTION OF THE INVENTION

First, an overview of embodiments of the present invention will be explained in brief as follows.

For example, in a mixed video delivered to the own device of a certain user A, the user A performs control so that the display of a facial image of a user B with whom the user A wants to hold a local conversation among other parties of communication displayed in the mixed video is enlarged and in this way the user A shortens the virtual sense of distance from the user B. In this case, the face of the user A is also automatically controlled so as to be displayed enlarged on the user B side and in this way the user B shortens the virtual sense of distance from the user A. In this condition, only the voice of the user A out of the mixed voices delivered to the user B is emphasized and mixed and only the voice of the user B out of the mixed voices delivered to the user A is emphasized and mixed. That is, after shortening the sense of distance, even if the user A and user B hold a conversation in voices which are lower than their normal voices, the conversation between the parties are emphasized and can be heard more easily as a consequence. On the other hand, other users hear the conversation of the user A and user B as just the same low voices. In this way, during a video-conference, it is possible to hold a local conversation in much the same way as an actual conference.

### First Embodiment

Hereinafter, a first embodiment of the present invention will be explained with reference to drawings.

First, a video-conferencing system using the present invention will be explained and then the effects thereof will be explained.

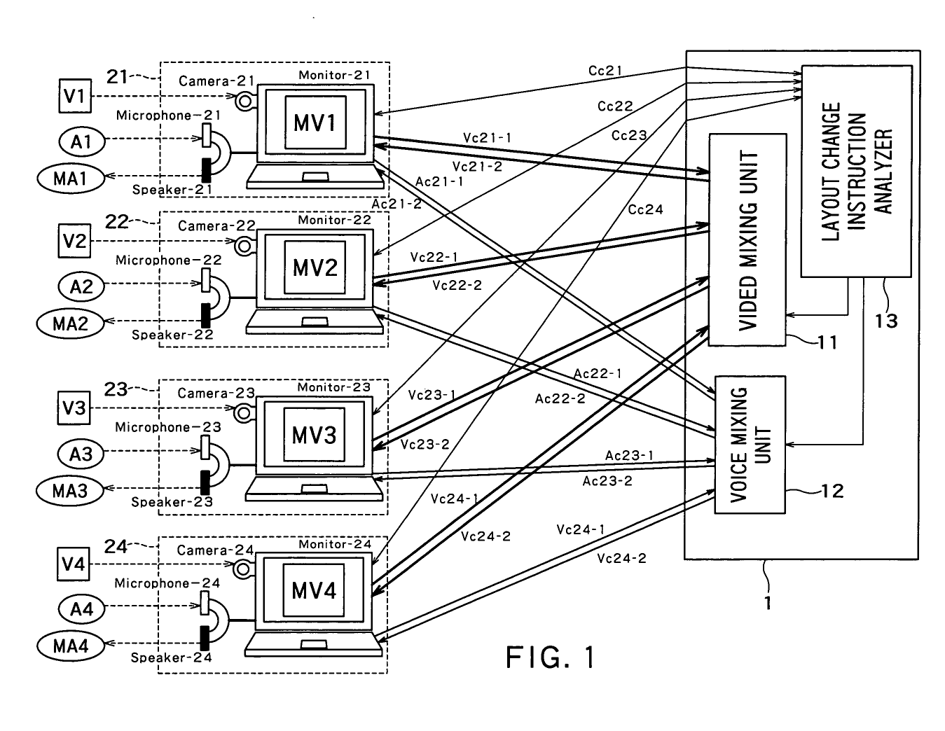

FIG. 1 shows a configuration example of a video-conferencing system. In the configuration example of FIG. 1, four conference terminals 21, 22, 23, 24 and a multipoint control unit 1 are connected to each other via a network. The multipoint control unit 1 of the present invention shown in FIG. 1 is equipped with a video mixing unit 11, a voice mixing unit 12 and a layout change instruction analyzer 13 as main components. The layout change instruction analyzer 13 is equivalent, for example, to a video control unit and a voice control unit.

Each conference terminal (21 to 24) is equipped with a camera device (Camera-21 to Camera-24) to take in an input video (V1 to V4), a microphone device (Microphone-21 to Microphone-24) to take in an input voice (A1 to A4), a display device (Monitor-21 to Monitor-24) to display a mixed video (MV1 to MV4) and a speaker device (Speaker-21 to Speaker-24) to reproduce a mixed voice (MA1 to MA4) respectively. On the other hand, the multipoint control unit 1 is equipped with the video mixing unit 11 which mixes input videos and outputs a mixed video, the voice mixing unit 12 which mixes input voices and outputs a mixed voice and the layout change instruction analyzer 13. Suppose the layout change instruction analyzer 13 generates a video mixing control signal and inputs it to the video mixing unit 11, and can thereby control a mixing method for the mixed video generated by the video mixing unit 11. Furthermore, according to the present invention, suppose this layout change instruction analyzer 13 generates a voice mixing control signal and inputs it to the voice mixing unit 12, and can thereby control a mixing method for the mixed voice generated by the voice mixing unit 12. Between the conference terminal 21 and the multipoint control unit 1, there is a communication route Vc21-1 to transmit a video from the conference terminal 21, a communication route Vc21-2 to transmit a mixed video from the multipoint control unit 1, a communication route Ac21-1 to transmit a voice from the conference terminal 21, a communication route Ac21-2 to transmit a mixed voice from the multipoint control unit 1, and there is also a communication route Cc-21 to send/receive a parameter when mixing a video between the conference terminal 21 and the multipoint control unit 1. Here, the “parameter” used when mixing the video transmitted from the conference terminal 21 is used to change a screen split layout of the mixed video transmitted from the multipoint control unit 1 to the conference terminal 21 (hereinafter referred to as “layout change parameter”). That is, by transmitting a layout change parameter from the conference terminal 21, it is possible to freely change the screen split layout of the mixed video delivered to the own terminal. Communication routes to send/receive a video, a voice and a layout change parameter are also provided between the conference terminal 22 and the multipoint control unit 1, between the conference terminal 23 and the multipoint control unit 1 and between the conference terminal 24 and the multipoint control unit 1 in the same way. The layout change parameter corresponds, for example, to video selection information.

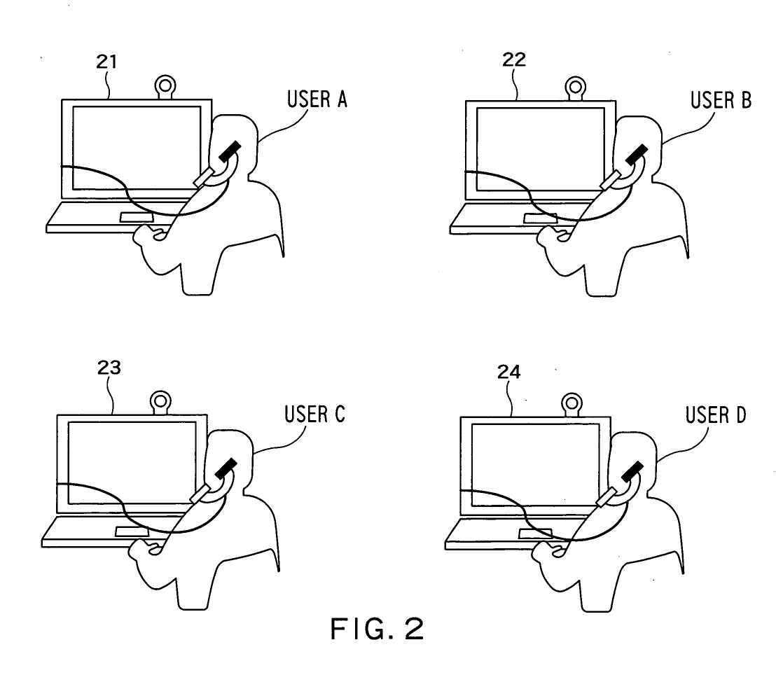

FIG. 2 shows a situation in which users A to D are operating conference terminals 21 to 24 respectively using the video-conferencing system in FIG. 1. When attention is focused on the user A and the conference terminal 21 here, in a first situation in which the video-conferencing system is started by four people, suppose the input video V1 is a video of the face of the user A, the input voice A1 is a voice of the user A and the mixed video MV1 is a video of the faces four users A, B, C, D arranged side by side and the mixed voice MA1 is a voice of the user B, C, D except A mixed together. The same applies to the users B, C, D, too, and when, for example, attention is focused on the user B and the conference terminal 22, in a first situation in which, for example, the video-conferencing system is started by four people, the input video V2 is a video of the face of the user B and the input voice A2 is a voice of the user B, the mixed video MV2 is a video of the faces of the four users A, B, C, D arranged side by side and the mixed voice MA2 is a voice of the user A, C, D except B mixed together.

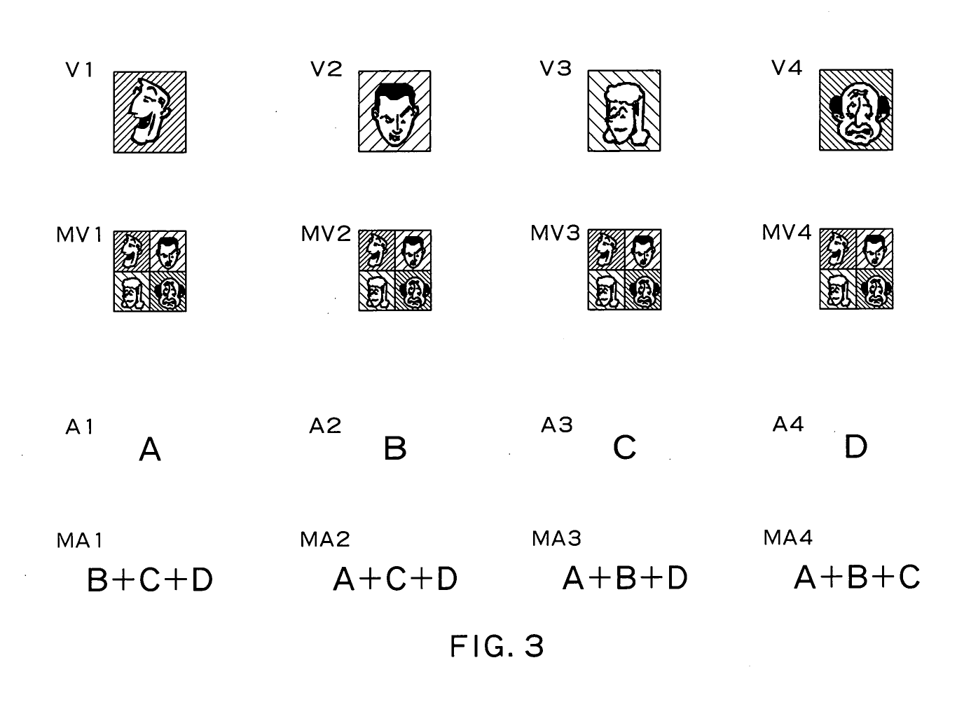

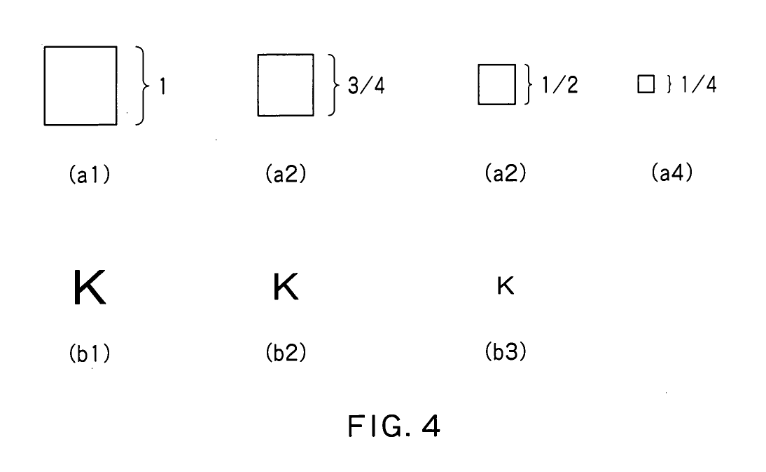

FIG. 3 shows the first situation in which the video-conferencing system is started by four people, illustrating the input videos (V1 to V4), input voices (A1 to A4), mixed videos (MV1 to MV4) and mixed voices (MA1 to MA4). The example of FIG. 3 shows a situation in which both image sizes of each input video and each mixed video are the same 320 pixels×240 pixels, the size of each input video is reduced to 160 pixels×120 pixels in the mixed video and then mixed together in the form in which one video is quadrisected. Furthermore, in the example of FIG. 3, suppose an average voice level of the respective input voices is the same and three voices are mixed as they are when a mixed voice is generated. FIG. 4 shows an illustration method used to express the size of an image and the intensity of a voice in this embodiment. In the case of a video, FIG. 4(a1) shows a video of 320×240 pixels, FIG. 4(a2) shows a video of 240×180 pixels, FIG. 4(a3) shows a video of 160×120 pixels and FIG. 4(a4) shows a video of 80×60 pixels. In the case of a voice, FIG. 4(b2) shows a reference voice level, FIG. 4(b1) shows a double voice level, FIG. 4(b3) shows a ½ voice level. That is, for both video and voice, the displayed sizes correspond to the video size and voice level.

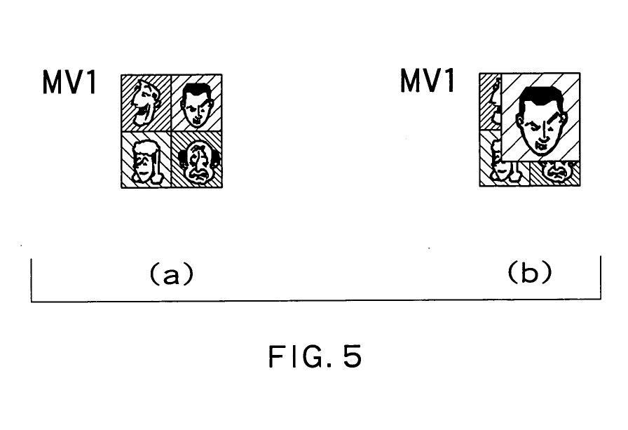

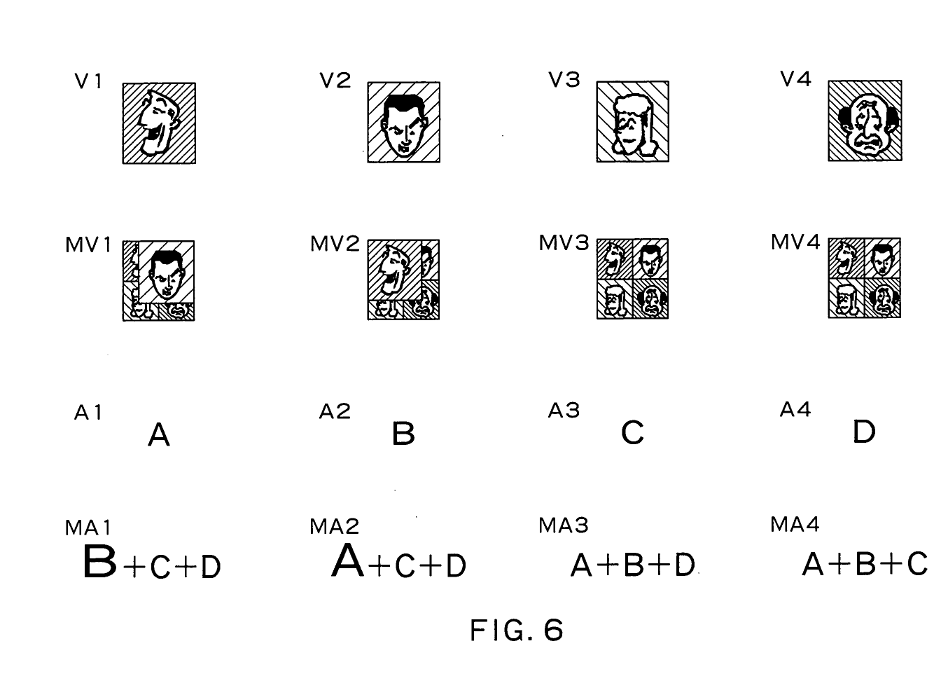

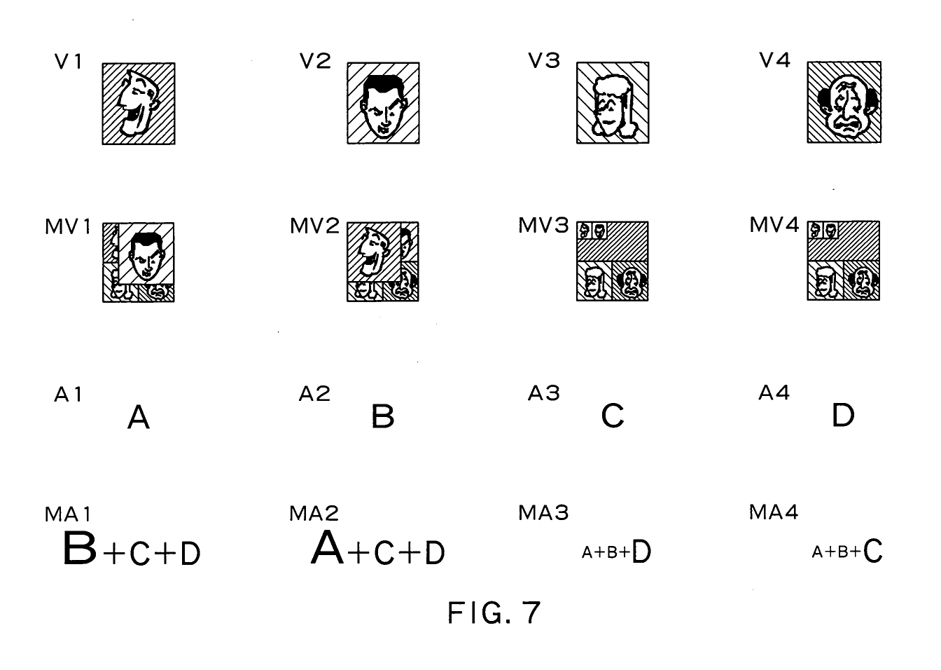

FIG. 5, FIG. 6 and FIG. 7 show the results of implementing the present invention. For example, suppose the user A of the conference terminal 21 sends a layout change parameter through the communication route Cc-21 to change the screen split layout of the mixed video in FIG. 5(a) delivered to himself/herself. Suppose change processing is performed so that the mixed video of the changed screen split layout becomes as shown in FIG. 5(b), that is, the facial image of the user B is displayed enlarged (the face of the user B becomes 240×180 pixels in the mixed video of 320×240 pixels). In this case, the layout change instruction analyzer 13 of the multipoint control unit 1 analyzes the layout change parameter received from the conference terminal 21, the layout change instruction analyzer 13 inputs a control signal to the video mixing unit 11 and thereby not only changes the layout of the mixed video to be delivered to the conference terminal 21 to that in FIG. 5(b) but also recognizes which video the conference terminal 21 has enlarged and automatically changes the layouts of the mixed videos to be delivered to the conference terminals other than the conference terminal 21. Furthermore, the layout change instruction analyzer 13 inputs a control signal to the voice mixing unit 12 and thereby automatically controls a mixed voice to be transmitted to each conference terminal.

FIG. 6 shows an example of the result of operations that the layout change instruction analyzer 13 of the multipoint control unit 1 analyzes the layout change parameter of the mixed video received from the conference terminal 21 and the video mixing unit 11 and the voice mixing unit 12 operate according to the analysis result of the layout change instruction analyzer 13. When the user A carries out change processing so that the facial image of the user B is displayed enlarged in the mixed video delivered to the own conference terminal 21, the video mixing unit 11 of the multipoint control unit 1 generates a mixed video in which the user B is displayed enlarged in the conference terminal 21 (e.g., changed to 240×180 pixels), generates a mixed video in which the user A is displayed enlarged in the conference terminal 22 (e.g., changed to 240×180 pixels) and delivers the respective videos. Furthermore, the voice mixing unit 12 of the multipoint control unit 1 generates a mixed voice in which the voice of the user B is made loud (the voice of the user B is superimposed at double intensity) in the conference terminal 21 and generates a mixed voice in which the voice of the user A is made loud (the voice of the user A is superimposed at double intensity) in the conference terminal 22 and delivers the respective voices. Instead of delivering the mixed voice in which the voice of the user B is made loud to the conference terminal 21 and delivering the mixed voice in which the voice of the user A is made loud to the conference terminal 22, it is also possible to generate a mixed voice in which the voices of the users C and D are made small without changing the voice level of the user B, deliver it to the conference terminal 21 and generate a mixed voice in which the voices of the users C and D are made small without changing the voice level of the user A, deliver it to the conference terminal 22.

FIG. 7 shows an example of the result of operations which is different from FIG. 6 that the layout change instruction analyzer 13 of the multipoint control unit 1 analyzes the layout change parameter of the mixed video received from the conference terminal 21 and the video mixing unit 11 and the voice mixing unit 12 operate according to the analysis result of the layout change instruction analyzer 13. When the user A carries out change processing so that the facial image of the user B is displayed enlarged in the mixed video delivered to the own conference terminal 21, not only the video mixing unit 11 and the voice mixing unit 12 perform the control in the case of FIG. 6 according to the analysis result of the layout change instruction analyzer 13 of the multipoint control unit 1 but also the video mixing unit 11 generates a mixed video where the user A and the user B are made small (e.g., changed to 80×60 pixels) in the conference terminal 23 and the conference terminal 24, the voice mixing unit 12 generates a mixed voice in which the voices of the user A and user B are made small (the voices of the user A and user B are superimposed at ½ intensity) and the mixed video and voice are delivered to the conference terminal 23 and the conference terminal 24 respectively.

Hereinafter, details of the method of implementing the present invention will be explained.

### (Conference Terminal)

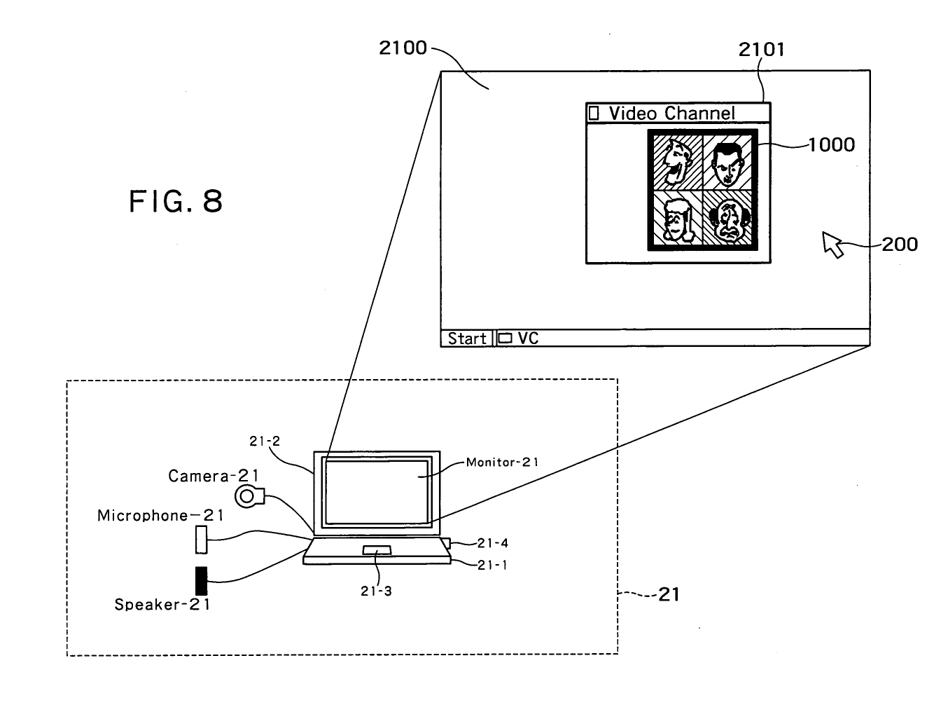

FIG. 8 shows an example of the configuration of the conference terminal 21 according to an embodiment of the present invention. The conference terminal 21 according to the present invention is implemented, for example, by a notebook portable personal computer. FIG. 8 shows an example where the present invention is implemented by a portable personal computer. The conference terminals 22, 23, 24 also have configurations similar to that of the conference terminal 21 and explanations thereof will be omitted below.

FIG. 8 shows the appearance of the conference terminal 21 which is a portable personal computer when the display unit thereof is opened. This conference terminal 21 is made up of a computer main unit 21-1 and a display unit 21-2. The display unit 21-2 is attached to the computer main unit 21-1 in a manner pivotally movable between an open position and a closed position. The display unit 21-2 incorporates a display device Monitor-21 such as LCD (Liquid Crystal Display) which makes up a display panel and the display device Monitor-21 is located substantially at the center of the display unit 21-2.

The computer main unit 21-1 has a thin box-shaped housing and a pointing device 21-3 and a keyboard are arranged on the top surface thereof. Moreover, a network communication device 21-4 is incorporated in the computer main unit 21-1.

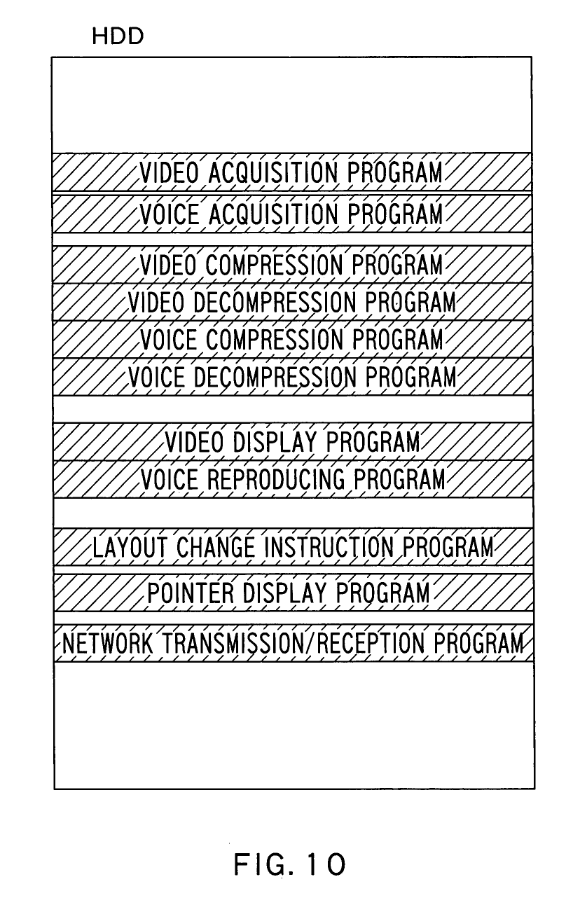

This network communication device 21-4 is a device to execute a communication over a network and designed to execute a communication defined, for example, as Ethernet. Alternatively, it is designed to execute a radio communication defined as IEEE802.11b or 802.11a. The communication operation of the network communication device 21-4 is controlled by a network transmission/reception program (see FIG. 10) which is a program executed within the conference terminal 21.

This network transmission/reception program has a function of transmission/reception processing on video data and voice data using RTP in addition to network protocol processing such as TCP/IP, UDP.

Furthermore, the computer main unit 21-1 is provided with terminals for a microphone input and a speaker output, and a microphone device Microphone-21 and a speaker device Speaker-21 or a headset which unites the microphone device Microphone-21 and the speaker device Speaker-21 as an earphone can be connected thereto.

The microphone device Microphone-21 connected to this microphone input terminal is a device to input a voice to the conference terminal 21. The voice input operation of the microphone device Microphone-21 is controlled by a voice acquisition program (see FIG. 10) which is the program executed inside the conference terminal 21. On the other hand, the speaker device Speaker-21 connected to this speaker output terminal is a device to output a voice from the conference terminal 21. The audio output operation of the speaker device Speaker-21 is controlled by a voice reproducing program (see FIG. 10) which is a program executed inside the conference terminal 21.

Furthermore, the computer main unit 21-1 includes a USB connection terminal and a camera device Camera-21 can be connected thereto.

The camera device Camera-21 connected to this USB connection terminal is a device to input a video to the conference terminal 21. The video input operation of the camera device Camera-21 is controlled by a video acquisition program (see FIG. 10) which is a program executed inside the conference terminal 21.

The display operation of the mixed video MVI is controlled by a video reproducing program (see FIG. 10) which is a program executed inside the conference terminal 21. Furthermore, the display control operation of a pointer 200 is controlled by a pointer display program (see FIG. 10) which is a program executed inside the conference terminal 21. The mixed video MV1 received from the multipoint control system 1 is displayed on the display screen of the display device Monitor-21. By operating the pointing device 14, it is possible to move the position of the pointer 200 or perform left clicking or right clicking on a display area 1000 in which the mixed video MV1 is displayed, for example, inside a window 2101 to display the mixed video MV1.

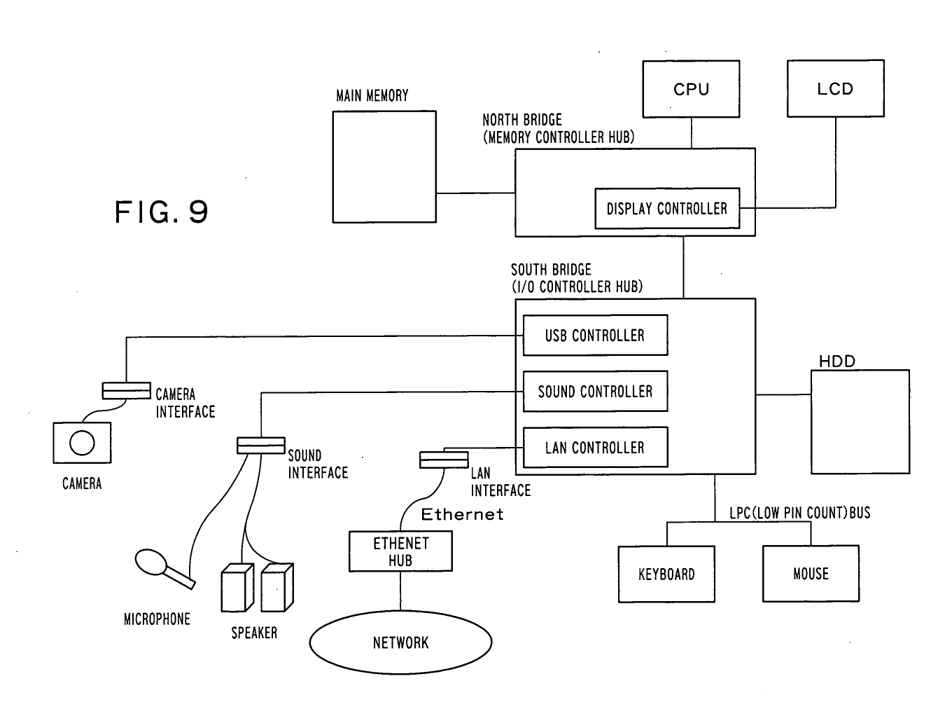

FIG. 9 shows the system configuration of the conference terminal 21. As shown in the figure, the conference terminal 21 incorporates a CPU, a north bridge (memory controller hub), a main memory, a south bridge (I/O controller hub), a hard disk drive (HDD) or the like and the north bridge is equipped with a display controller and the south bridge is equipped with a USB controller, a sound controller and a LAN controller.

The CPU is a processor provided to control the operation of the conference terminal 21 and executes the operating system (OS) and various application programs loaded into the main memory from the hard disk drive (HDD). FIG. 10 shows the application programs stored in the hard disk drive. In addition to the network transmission/reception program, the pointer display program, the video acquisition program, the video reproducing program, the voice acquisition program and the voice reproducing program, this embodiment loads a video compression program, a video decompression program, a voice compression program, a voice decompression program and a layout change instruction program into the main memory from hard disk drive (HDD) and the CPU executes those programs. The video compression program executes processing according to the video acquisition program and executes processing of compressing and coding the video data acquired from the video acquisition program into a format such as MPEG4 and the network transmission/reception program transmits the video data compressed and coded according to the video compression program. The video decompression program executes processing according to the network transmission/reception program and executes processing of decompressing and decoding the received video data compressed and coded subjected to reception processing by the network transmission/reception program into a format such as MPEG4 into non-compressed video data and the video reproducing program displays the video data converted to the non-compressed data according to the video decompression program. The voice compression program executes processing according to the voice acquisition program, executes processing of compressing and coding the voice data acquired by the voice acquisition program into a format such as G.711 and the network transmission/reception program transmits the voice data compressed and coded according to the voice compression program. The voice decompression program executes processing according to the network transmission/reception program, executes processing of decompressing and decoding the received voice data compressed and coded into a format such as G.711 subjected to reception processing by the network transmission/reception program into non-compressed voice data and the voice reproducing program reproduces the non-compressed voice data according to the voice decompression program. The layout change instruction program executes processing according to the pointer display program and executes a series of processes such as moving the position of the pointer 200 on a video displayed by the video reproducing program, calculating, when left clicking or right clicking is executed, a layout of the mixed video from the operation of the pointing device 21-3, generating a layout change parameter indicating the calculated layout and sending a layout change parameter to the multipoint control unit 1 using the network transmission/reception program. The more specific processing functions of this layout change instruction program will be described later.

The north bridge is a bridge device which bidirectionally connects a local bus of the CPU and a high-speed bus between the north bridge and the south bridge. The north bridge incorporates a display controller. The display controller controls the display device Monitor-21 which is used as the display monitor of the conference terminal 21. The display controller in this embodiment displays a mixed video on the display device Monitor-21 according to the video display program.

The south bridge is a bridge device which bidirectionally connects the high-speed bus on the north bridge side and a low-speed bus which connects a keyboard or the like. The south bridge incorporates the USB (Universal Serial Bus) controller. The camera device Camera-21 is connected to this USB controller. The camera device Camera-21 captures a video under the control of the video acquisition program and converts the captured video to an electric signal so that the captured video can be processed inside the conference terminal 21. Furthermore, the south bridge also incorporates the sound controller. The microphone device Microphone-21 and the speaker device Speaker-21 are connected to this sound controller. The microphone device Microphone-21 collects sound under the control of the voice acquisition program and converts the collected sound to an electric signal so that the sound can be processed inside the conference terminal 21. The speaker device Speaker-21 reproduces the sound processed as an electronic signal inside the conference terminal 21 under the control of the voice reproducing program as a sound wave. The south bridge also incorporates the LAN controller. The network communication device 21-4 such as a physical layer device of Ethernet is connected to this LAN controller. The network communication device 21-4 modulates transmission data and demodulates received data under the control of the network transmission/reception program.

### (Multipoint Control Unit)

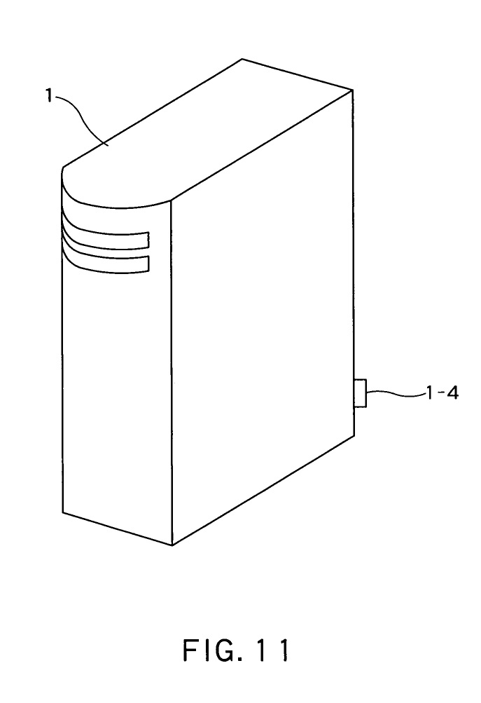

FIG. 11 shows an example of the configuration of the multipoint control unit 1 according to the embodiment of the present invention. The multipoint control unit 1 according to the present invention is implemented, for example, by a high performance computer available as a server machine. FIG. 11 shows an example where the multipoint control unit 1 is implemented as a tower type personal computer. The multipoint control unit 1 which is a tower type personal computer incorporates a network communication device 1-4.

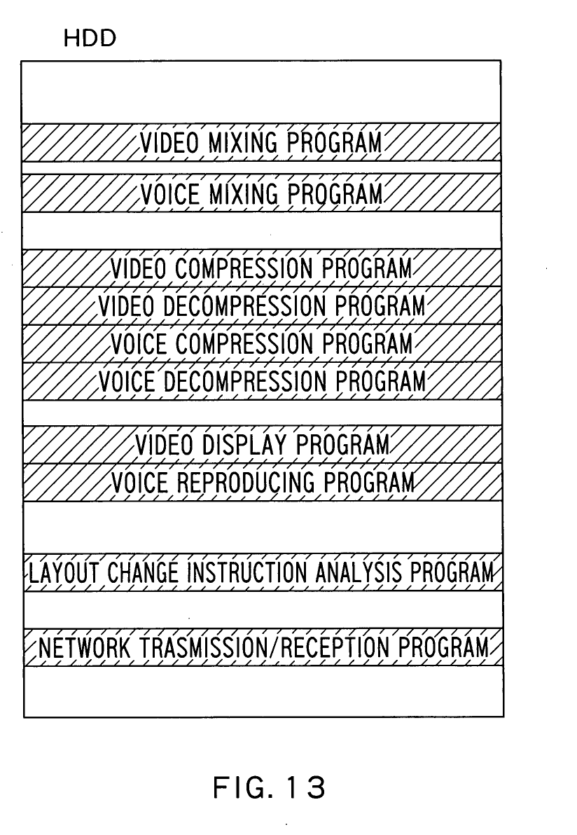

This network communication device 1-4 is a device which executes a network communication and is designed to execute a communication specified, for example, as Ethernet. Alternatively, it is designed to execute a radio communication specified as IEEE 802.11b or 802.11a. The communication operation of the network communication device 1-4 is controlled by the network transmission/reception program (see FIG. 13) which is a program executed inside the multipoint control unit 1.

This network transmission/reception program has a function of transmission/reception processing on video data and voice data by RTP in addition to network protocol processing such as TCP/IP, UDP.

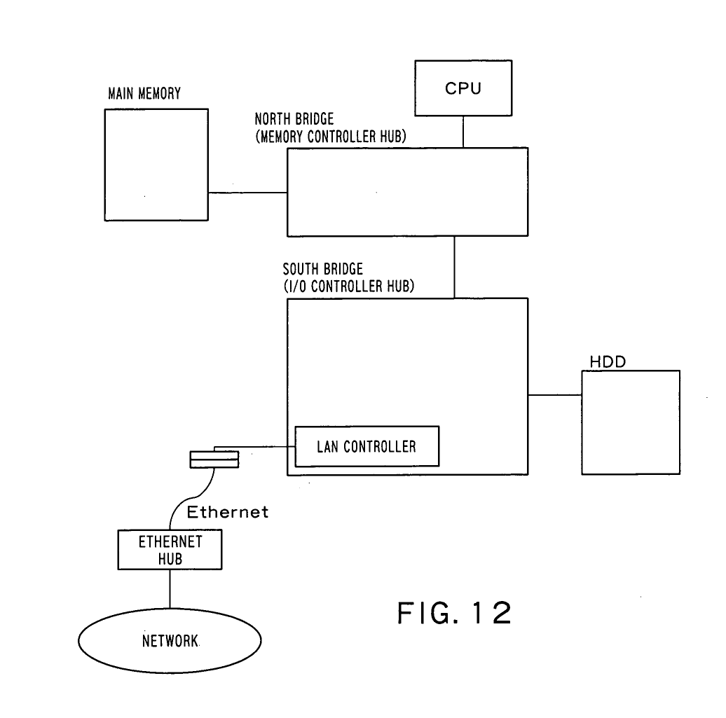

FIG. 12 shows the system configuration of the multipoint control unit 1. As illustrated in the figure, the multipoint control unit 1 incorporates a CPU, a north bridge (memory controller hub), a main memory, a south bridge (I/O controller hub), a hard disk drive (HDD) or the like.

The CPU is a processor provided to control the operation of the multipoint control unit 1 and executes the operating system (OS) and various application programs loaded into the main memory from the hard disk drive (HDD). FIG. 13 shows the application programs stored in the hard disk drive. In addition to the network transmission/reception program, this embodiment loads a video mixing program, a voice mixing program, a video compression program, a video decompression program, a voice compression program, a voice decompression program and a layout change instruction analysis program into the main memory from the hard disk drive (HDD) and the CPU executes those programs.

The video compression program executes processing according to the video mixing program and executes processing of compressing and coding the mixed video data generated by the video mixing program into a format such as MPEG4 and the network transmission/reception program transmits the compressed and coded video data according to the video compression program.

The video decompression program executes processing according to the network transmission/reception program and executes processing of decompressing and decoding the received video data compressed and coded into a format such as MPEG4 subjected to reception processing by the network transmission/reception program into non-compressed video data and the video mixing program generates a mixed video using the non-compressed video data according to the video decompression program.

The voice compression program executes processing according to the voice mixing program, executes processing of compressing and coding the mixed voice data generated by the voice acquisition program into a format such as G.711 and the network transmission/reception program transmits the compressed and coded voice data according to the voice compression program.

The voice decompression program executes processing according to the network transmission/reception program, executes processing of decompressing and decoding the received voice data compressed and coded into a format such as G.711 subjected to reception processing by the network transmission/reception program into non-compressed voice data and the voice mixing program generates a mixed voice using the non-compressed voice data according to the voice decompression program.

The layout change instruction analysis program executes processing according to the network transmission/reception program and executes analysis processing on the layout change parameter subjected to reception processing by the network transmission/reception program. The video mixing program changes the screen split layout of the mixed video according to the analysis result of the layout change instruction analysis program. Furthermore, the layout change instruction analysis program calculates, when generating a mixed voice, the level of the volume of each voice in the case of the analysis processing on the layout change parameter. The voice mixing program adjusts the volume of each voice in the case of the mixed voice according to the calculation result of the layout change instruction analysis program.

The more specific processing functions of the layout change instruction program, video mixing program and voice mixing program will be described later.

The video compression program and the video decompression program at the multipoint control unit 1 in this embodiment process four videos at the same time independently. Furthermore, the voice compression program and the voice decompression program at the multipoint control unit 1 process four voices at the same time independently. Furthermore, the video mixing program generates four independent mixed videos using four videos. Furthermore, the voice mixing program generates four independent mixed voices using four voices. Furthermore, the network transmission/reception program performs transmission/reception processing on videos and voices of the four conference terminals and reception processing on the layout change parameter independently of each other.

The north bridge is a bridge device which bidirectionally connects a local bus of the CPU and a high-speed bus between the north bridge and the south bridge.

A LAN controller is incorporated in the south bridge. The network communication device 1-4 such as a physical layer device of Ethernet is connected to this LAN controller. The network communication device 1-4 modulates transmission data and demodulates received data under the control of the network transmission/reception program.

### (Internal Configuration of Conference Terminal)

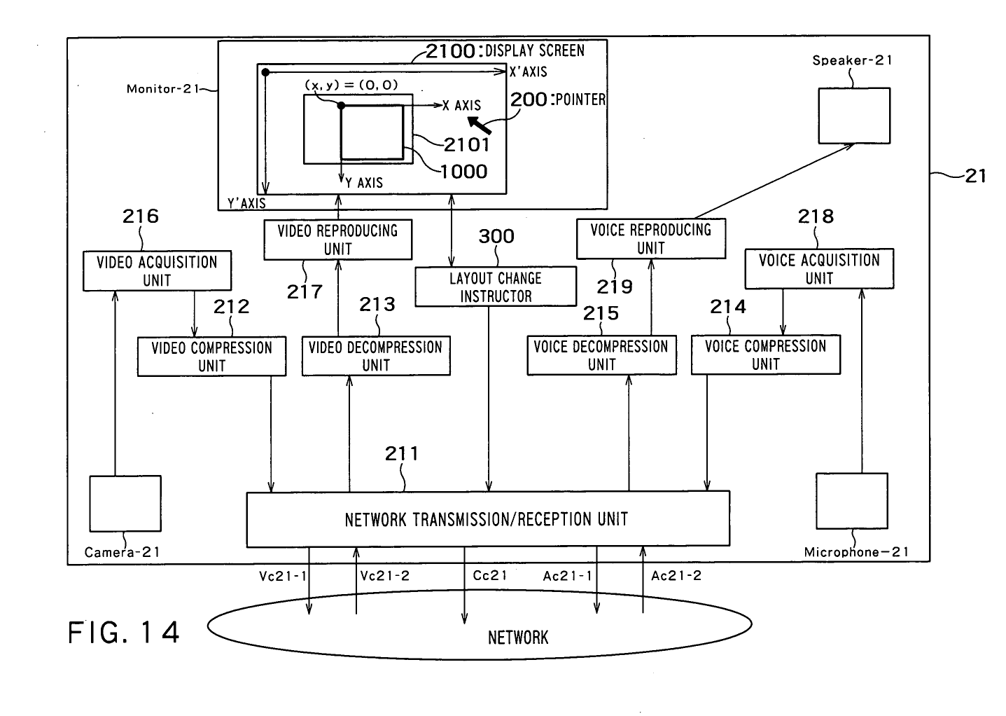

FIG. 14 shows internal components of the conference terminal 21 shown in FIG. 8 and FIG. 9 according to the present invention. In FIG. 14, components (e.g., CPU) which have no direct influence in realizing functional improvements according to the present invention are omitted.

As internal components, the conference terminal 21 is provided with a network transmission/reception unit 211, a video compression unit 212, a video decompression unit 213, a voice compression unit 214, a voice decompression unit 215, a video acquisition unit 216, a video reproducing unit 217, a voice acquisition unit 218, a voice reproducing unit 219 and a layout change instructor 300. The above described network transmission/reception unit 211, video compression unit 212, video decompression unit 213, voice compression unit 214, voice decompression unit 215, video acquisition unit 216, video reproducing unit 217, voice acquisition unit 218, voice reproducing unit 219 and layout change instructor 300 are realized by the processing routines of the network transmission/reception program, video compression program, video decompression program, voice compression program, voice decompression program, video acquisition program, video reproducing program, voice acquisition program, voice reproducing program and layout change instruction program shown in FIG. 10 respectively.

The video reproducing unit 217 allows drawing data created inside to be displayed on the display screen 2100 shown in FIG. 8. Furthermore, the network transmission/reception unit 211 can transmit video data using the communication channel Vc21-1 shown in FIG. 1, receive video data using the communication channel Vc21-2, transmit voice data using the communication channel Ac21-1, receive voice data using the communication channel Ac21-2, transmit/receive a layout change parameter when mixing videos using the communication channel Cc-21. The network transmission/reception unit 211 sends/receives video data and voice data using, for example, UDP/IP, RTP as the communications protocol and transmits a layout change parameter when mixing videos using UDP/IP or TCP/IP.

The network transmission/reception unit 211 sends/receives video data and voice data in a streaming format, manages the start and end of transmission/reception thereof, can identify video data and voice data that are sent/received, and sends/receives video data and voice data using appropriate communication channels. Upon receiving video data, the network transmission/reception unit 211 outputs the video data to the video decompression unit 213 and upon receiving voice data, the network transmission/reception unit 211 outputs the voice data to the voice decompression unit 215.

The video acquisition unit 216 controls the camera device Camera-21, instructs the start of video capturing and end of video capturing. When video capturing is started, the video (V1) captured by the camera device Camera-21 is inputted to the video acquisition unit 216 as video data. The video acquisition unit 216 outputs the video data to the video compression unit 214 to transmit the input video data to the multipoint control system 1. When the video data is inputted, the video compression unit 214 encodes (compresses) the video data into MPEG4 and outputs the video data to the network transmission/reception unit 211. The network transmission/reception unit 211 performs processing on the compressed video data so as to be transmitted to the multipoint control apparatus 1 through a network and then transmits the video data using the communication channel Vc21-1.

The voice acquisition unit 218 controls the microphone device Microphone-21 and instructs the start of sound collection and the end of video capturing. When sound collection starts, the voice (A1) being collected by the microphone is inputted to the voice acquisition unit 218 as voice data. The voice acquisition unit 218 outputs the voice data to the voice compression unit 214 so as to transmit the inputted voice data to the multipoint control apparatus 1. When the voice data is inputted, the voice compression unit 214 encodes (compresses) the voice data into G.711 and outputs it to the network transmission/reception unit 211. The network transmission/reception unit 211 performs processing on the compressed voice data so as to be transmitted to the multipoint control apparatus 1 through the network and then transmits the voice data using the communication channel Ac21-1.

When receiving data from the Vc21-2, the network transmission/reception unit 211 outputs the compressed video data included in the received data to the video decompression unit 213. When the compressed video data is inputted, the video decompression unit 213 decodes (decompresses) it, generates non-compressed video data and outputs the non-compressed video data generated to the video reproducing unit 217. The video reproducing unit 217 is equipped with the function of controlling the display device Monitor-21, creating and displaying the window 2101 as an application and displays, when displayable video data is inputted, the video data as “mixed video MV1” in the display area 1000 in the window 2101.

When receiving data from the Ac21-2, the network transmission/reception unit 211 outputs the compressed voice data included in the received data to the voice decompression unit 215. When the compressed voice data is inputted, the voice data voice decompression unit 215 decodes (decompresses) it, generates non-compressed voice data and outputs the non-compressed voice data generated to the voice reproducing unit 219. The voice reproducing unit 219 controls the speaker device Speaker-21 and reproduces the voice data inputted as “mixed voice MA1”.

An example of the embodiment of the layout change instructor 300 will be shown below.

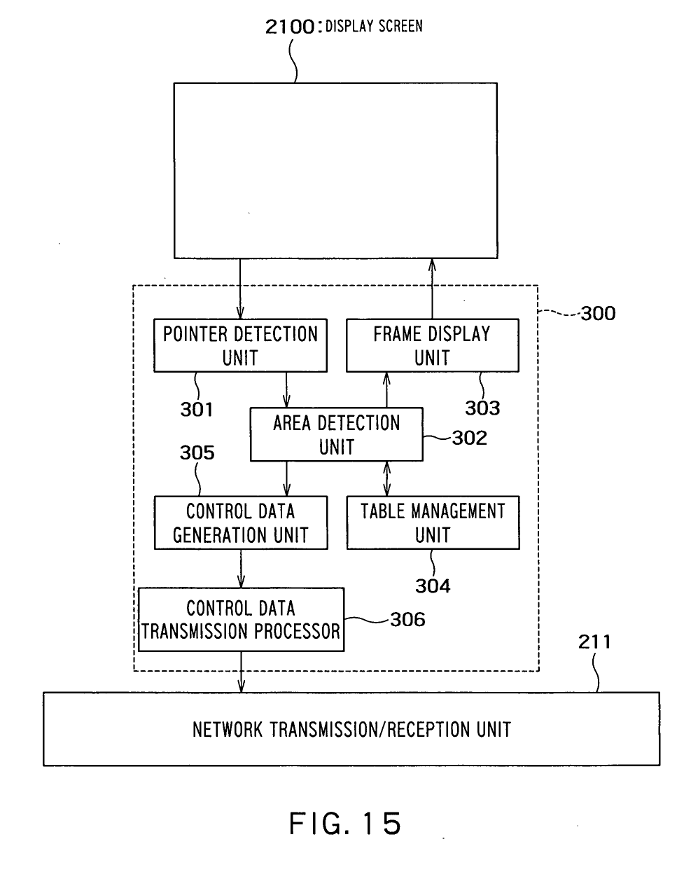

FIG. 15 shows components of the layout change instructor 300. The Layout change instructor 300 is made up of a pointer detection unit 301, an area detection unit 302, a frame display unit 303, a table management unit 304, a control data generation unit 305 and a control data transmission processor 306.

First, the operation when the layout change instructor 300 is initialized will be explained.

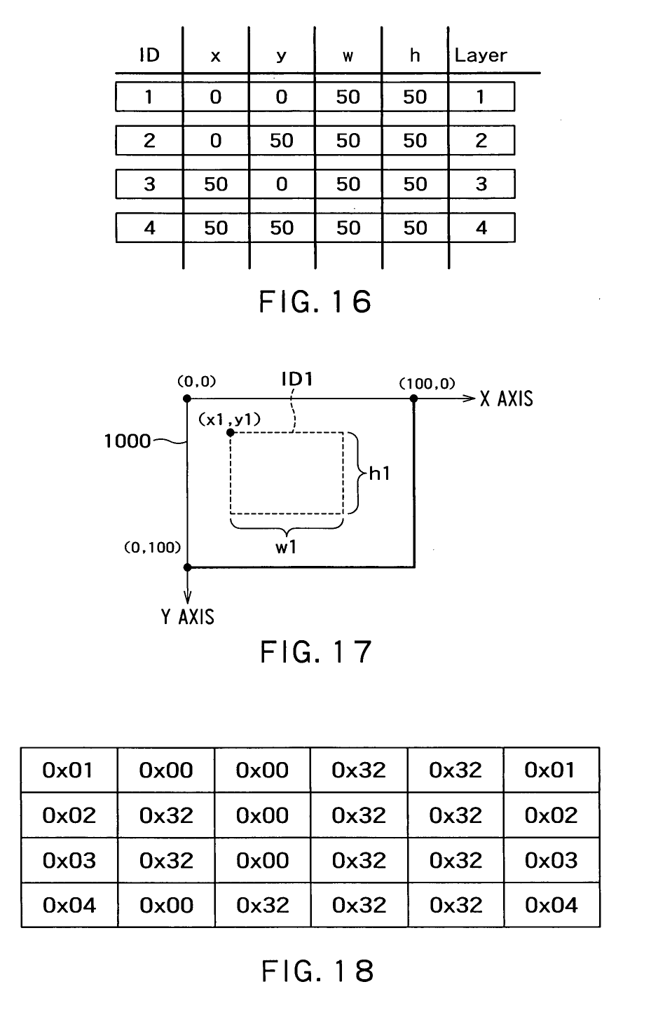

The table management unit 304 internally creates and stores an area management table which is shown in FIG. 16. FIG. 16 is the area management table at the time of initialization which assigns IDs (1, 2, 3, 4) to four types of videos (hereinafter referred to as “video sources”) for identification which can be mixed by the multipoint control unit 1 and includes parameter information “x”, “y”, “w”, “h” and “Layer” indicating their respective arrangement positions. “x”, “y”, “w”, “h” indicate the positions at which the video sources identified by IDs are arranged in a mixed image and the sizes when the video sources are assumed to be rectangles. When FIG. 17 is taken as an example for explanation, the rectangular area with ID=1 is defined by x=x1, y=y1, w=w1, h=h1. Furthermore, “Layer” indicates hierarchical information to identify a relationship between superior and inferior among the respective video source when the multipoint control unit 1 creates a mixed video. For example, when a video source is located in a kth layer, Layer=k, and the video source in the kth layer is located immediately behind the video source in the (k−1)th layer and when a mixed video in which the video sources in the kth layer and the (k−1)th layer overlap each other is created, some part of the video source in the kth layer is hidden behind the video source in the (k−1)th layer. When the layout change instructor 300 is initialized, suppose the area management table under the management of the table management unit 304 is set in the condition at the time of initialization in FIG. 16.

When the layout change instructor 300 is initialized, the area detection unit 302 acquires the area management table information in the initialized condition from the table management unit 304 and outputs the area management table information to the control data generation unit 305.

When the area management table information is inputted from the area detection unit 302, the control data generation unit 305 builds a payload unit of a mixed video control packet to transmit the area management table information to the multipoint control unit 1. FIG. 18 shows an example of the payload unit of the mixed video control packet when the area management table information is initialized. Each block in FIG. 18 shows 8-bit information and expresses a bit string in hexadecimal numbers. FIG. 18 expresses information by turning down each line every 6 bytes. After creating the mixed video control packet, the control data generation unit 305 outputs it to the control data transmission processor 306.

Upon receiving the mixed video control packet from the control data generation unit 305, the control data transmission processor 306 outputs this control packet to the network transmission/reception unit 211 together with additional information such as the destination address information of the network which is necessary to transmit this control packet to the multipoint control unit 1. When the mixed video control packet with the additional information added is inputted from the control data transmission processor 306, the network transmission/reception unit 211 transmits this mixed video control packet to the multipoint control unit 1 as the layout change parameter through the communication channel Cc21.

Next, the operation of the layout change instructor 300 accompanied by the user's operation after initialization will be explained.

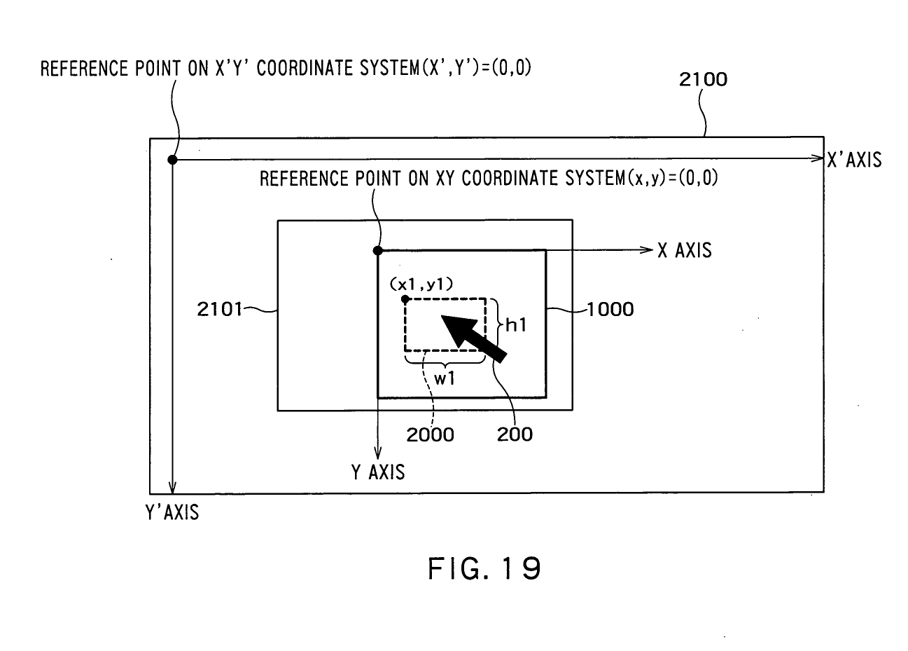

The pointer detection unit 301 detects that the pointer 200 is in the display area 1000 of the mixed video MV1 in the window 2101 in the display screen 2100 and when an operation event further occurs at the position, the pointer detection unit 301 detects the event. An operation event is generated by clicking, double-clicking, drag and drop or the like through operations of the pointing device 21-3. As shown in FIG. 19, by managing the display screen 2100 with X′Y′ coordinates, the pointer detection unit 301 can manage the position of the pointer 200 and the position of the window 2101 on the display screen 2100. When detecting that an operation event has occurred in the display area 1000, the pointer detection unit 301 outputs the position information (expressed using X′Y′ coordinates) of the pointer 200 and operation event information (left clicking, left clicking or cancellation of right clicking or the like) to the area detection unit 302.

As shown in FIG. 19, the area detection unit 302 manages the display area 1000 in the window 2101 with XY coordinates. In the case of a valid operation event, the area detection unit 302 converts position information (expressed using X′Y′ coordinates) of the pointer 200 inputted from the pointer detection unit 301 to XY coordinates and recognizes the converted value as the position information of the pointer 200. On the other hand, in the case of an invalid operation event, the area detection unit 302 ignores the position information (expressed using X′Y′ coordinates) of the pointer 200 and operation event information. When, for example, only left clicking and cancellation of left clicking are assumed to be valid operation events, the area detection unit 302 analyzes position information of the pointer 200 only in the case of left clicking and cancellation of left clicking. The relationship between XY coordinates and the display area 1000 under the management of the area detection unit 302 will be explained using FIG. 19. When a point on XY coordinates is expressed as (x,y), the area detection unit 302 manages a vertex at top left of the display area 1000 as (0,0), a vertex at top right as (100,0), a vertex at bottom left as (0,100) and a vertex at bottom right as (100,100). That is, the area detection unit 302 manages a position in the display area 1000 by normalizing it to a value of 100 in the horizontal direction and vertical direction of the display area 1000. When, for example, left clicking occurs at the position of (x1,y1) shown in FIG. 19, the area detection unit 302 recognizes information of {x1, y1, event A}. Here, the “event A” indicates that left clicking is performed and defines information of {x1, y1, event A} as a “position confirmation signal” as internal processing. When recognizing the position confirmation signal {x1, y1, event A}, the area detection unit 302 acquires area management table information from the table management unit 304 and confirms the registration information of the area management table. When the position information of x1, y1 is a point that does not belong to any of rectangular areas under the management of the area management table, the area detection unit 302 ends the processing on the position confirmation signal {x1, y1, event A}. On the other hand, when the position information of x1, y1 is a point which belongs to a plurality of rectangular areas under the management of the area management table, the area detection unit 302 confirms “Layer” and recognizes the ID number of the rectangular area located at the top and the information related thereto (x, y, w, h, Layer) as rectangular area information {ID, x, y, w, h, Layer}. Upon recognizing the rectangular area information {ID, x, y, w, h, Layer}, the area detection unit 302 stores the information inside and outputs it to the frame display unit 303.

When the rectangular area information {ID, x, y, w, h, Layer} is inputted from the area detection unit 302, the frame display unit 303 displays, using the values of x, y, w, h, the rectangular frame 2000 in the display area 1000 in the window 2101 of the display screen 2100 managed with XY coordinates. FIG. 19 shows a situation in which when the rectangular area information {ID=ID1, x=x1, y=y1, w=w1, h=h1, Layer=I1} is inputted, the corresponding rectangular frame 2000 is displayed in the display area 1000. The rectangular frame 2000 may also be a solid line other than the broken line and dotted line shown in FIG. 19 and the display color of the frame may be changed according to the ID number. The area detection unit 302 has been described above as storing the rectangular area information {ID, x, y, w, h, Layer}, but when the stored rectangular area information is deleted, the area detection unit 302 outputs a deletion instruction of the rectangular area information {ID, x, y, w, h, Layer} to the frame display unit 303. Upon receiving the deletion instruction, the frame display unit 303 executes processing so as not to display the specified rectangular frame. When the value of the rectangular area information {ID, x, y, w, h, Layer} stored inside has not been changed for a predetermined time, the area detection unit 302 is assumed to delete the stored rectangular area information. The area detection unit 302 may also be adapted so as to be able to store a plurality of pieces of rectangular area information inside or may also be adapted so as to be able to store only one piece of information inside and delete old rectangular area information when new rectangular area information is stored. As for the rectangular area information {ID, x, y, w, h, Layer} stored inside, the area detection unit 302 can change the value through “rectangular frame change processing” which will be described later.

Here, the method whereby the user moves the display position of the pointer 200 and changes the size and position of the rectangular frame displayed by the frame display unit 303 will be described. As shown above, the pointer detection unit 301 detects the position of the pointer 200 and outputs the position information (expressed using X′Y′ coordinates) of the pointer 200 and operation event information (left clicking, cancellation of left clicking and right clicking or the like) to the area detection unit 302. When the operation event information inputted is valid, the area detection unit 302 temporarily stores the position information (expressed using X′Y′ coordinates) of the pointer 200 converted to XY coordinates and operation event information. At this time, the area detection unit 302 detects whether or not the positions of the detected XY coordinates belong to the area of the rectangular area information {ID, x, y, w, h, Layer} stored inside and carries out, when the positions of the detected XY coordinates do not belong to the area, processing on the “position confirmation signal” described above, but when the positions of the detected XY coordinates are detected to belong to the area, the area detection unit 302 executes the “rectangular frame change processing”. The explanation of the processing on the “position confirmation signal” described above corresponds to the case where the rectangular area information is not stored inside the area detection unit 302.

Hereinafter, the “rectangular frame change processing” will be explained using FIG. 19.

First, suppose a case where the pointer 200 is moved to a vertex of the rectangular frame 2000, the left button is clicked there, the pointer 200 is moved with the left button being kept clicked and left clicking is canceled after the pointer 200 is moved. In this case, the pointer detection unit 301 detects the first left clicking and inputs the information to the area detection unit 302 and the area detection unit 302 thereby recognizes that the vertex of the rectangular frame 2000 is the start of the specified “rectangular frame change processing”. Next, the pointer detection unit 301 detects the movement of the pointer and inputs the information to the area detection unit 302 and the area detection unit 302 can thereby recognize that it is the processing of changing the size of the rectangular frame 2000. Furthermore, the pointer detection unit 301 detects that left clicking is canceled and inputs the information to the area detection unit 302 and the area detection unit 302 can thereby recognize that the processing of changing the size of the rectangular frame 2000 is confirmed, that is, the end of the “rectangular frame change processing”. When the area detection unit 302 recognizes the processing of changing the size of the rectangular frame 2000, it changes the values of x, y, w, h of the rectangular area information {ID, x, y, w, h, Layer} stored inside as required and outputs the changed rectangular area information to the frame display unit 303. For example, in the processing whereby the size of the frame is changed by changing the position of the vertex clicked with the left button, the area detection unit 302 changes the values of x, y, w, h as appropriate so that the opposite angle position of the clicked vertex is fixed. At some midpoint of the processing of changing the size of the rectangular frame 2000, the area detection unit 302 outputs the rectangular area information at any time only for the frame display unit 303 so that the display of the rectangular frame in the display area 1000 is changed and upon recognizing the end of the “rectangular frame change processing”, the area detection unit 302 changes the information of x, y, w, h, Layer of the corresponding ID in the area management table under the management of the table management unit 304 and outputs the changed area management table information to the control data generation unit 305. In this embodiment, suppose a length-to-width aspect ratio of the rectangular frame is kept constant and when the position of the pointer 200 does not satisfy the requirement that the aspect ratio be kept constant when the end of the “rectangular frame change processing” is recognized, the pointer detection unit 301 automatically corrects the position of the pointer 200 to a point where the requirement that the aspect ratio be kept constant is satisfied. Furthermore, suppose the size can be changed only to four fixed sizes of a maximum display size (320 pixels×240 pixels in this embodiment) and sizes ¾, ½ and ¼ thereof in the display area 1000. When the frame does not fit into these sizes, suppose the frame is automatically corrected to a closest one among these sizes.

Next, suppose the pointer 200 is moved to a position located in an area within the rectangular frame 2000 yet other than the vertices, the left button is clicked there, the pointer 200 is moved with the left button being kept clicked and left clicking is canceled after the pointer 200 is moved. In this case, the pointer detection unit 301 detects the first left clicking and inputs the information to the area detection unit 302 and the area detection unit 302 thereby recognizes any position other than the vertices of the rectangular frame 2000 as the start of the specified “rectangular frame change processing”. Next, the pointer detection unit 301 detects the movement of the pointer 200 and inputs the information to the area detection unit 302 and the area detection unit 302 can thereby recognize that it is the processing of changing the position of the rectangular frame 2000. Furthermore, the pointer detection unit 301 detects that the left clicking is canceled and inputs the information to the area detection unit 302, and the area detection unit 302 can thereby recognize that the processing of changing the position of the rectangular frame 2000 has been confirmed, that is, the end of the “rectangular frame change processing”. When the area detection unit 302 recognizes the processing of changing the position of the rectangular frame 2000, it changes the values of x, y of the rectangular area information {ID, x, y, w, h, Layer} stored inside and outputs the changed rectangular area information to the frame display unit 303. For example, when the size of the frame is assumed not to change in the processing of changing a position, the values of x, y are changed as appropriate using the value of difference between the position of the pointer 200 recognized at the start of the “rectangular frame change processing” and the position of the pointer 200 in movement. At some midpoint of the processing of changing the position of the rectangular frame 2000, the area detection unit 302 outputs the rectangular area information as appropriate only to the frame display unit 303 so that the display of the rectangular frame is changed in the display area 1000 and at the time point of recognizing the end of the “rectangular frame change processing”, the area detection unit 302 changes the information of x, y, w, h, Layer of the corresponding ID in the area management table under the management of the table management unit 304 and outputs the changed area management table information to the control data generation unit 305.

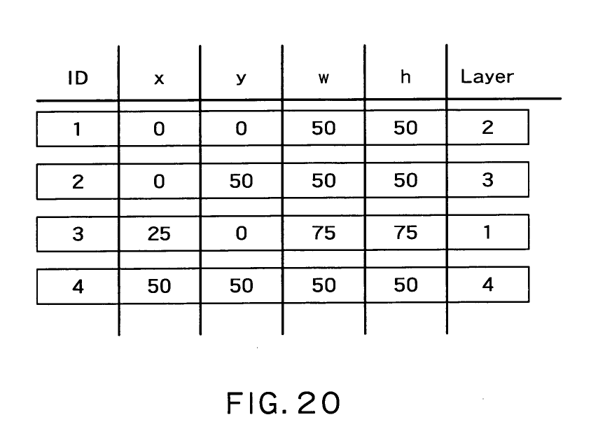

In the case of the processing of changing the size or the position of the rectangular frame 2000, the area detection unit 302 changes the information of x, y, w, h, Layer of the corresponding ID in the area management table under the management of the table management unit 304, but it is also possible to perform such control that the Layer with the corresponding ID is set to 1 and the corresponding video source is arranged at the top. In this case, the value of the layer which was previously 1 in the area management table is incremented by 1. If this results in an overlap with other registered information, the value of the layer of the other registered information is incremented by 1. FIG. 20 shows the area management table where the size of the rectangular frame 2000 has been changed from the initialized condition and this example shows that the information corresponding to ID=3 has been changed, and as for the hierarchy, the Layer value of ID=3 has been changed to 1 and the Layer values of ID=1 and ID=2 have been changed to 2 and 3 respectively.

The processing at the control data generation unit 305 and the control data transmission processor 306 when area management table information is inputted corresponds to that explained above as the operation when the layout change instructor 300 is initialized.

On the other hand, when the conference terminal 21 contrarily receives a mixed video control packet from the multipoint control unit 1, suppose the conference terminal 21 extracts the area management table included therein and overwrites the area management table information under the own management therewith.

### (Internal Configuration of Multipoint Control Unit)

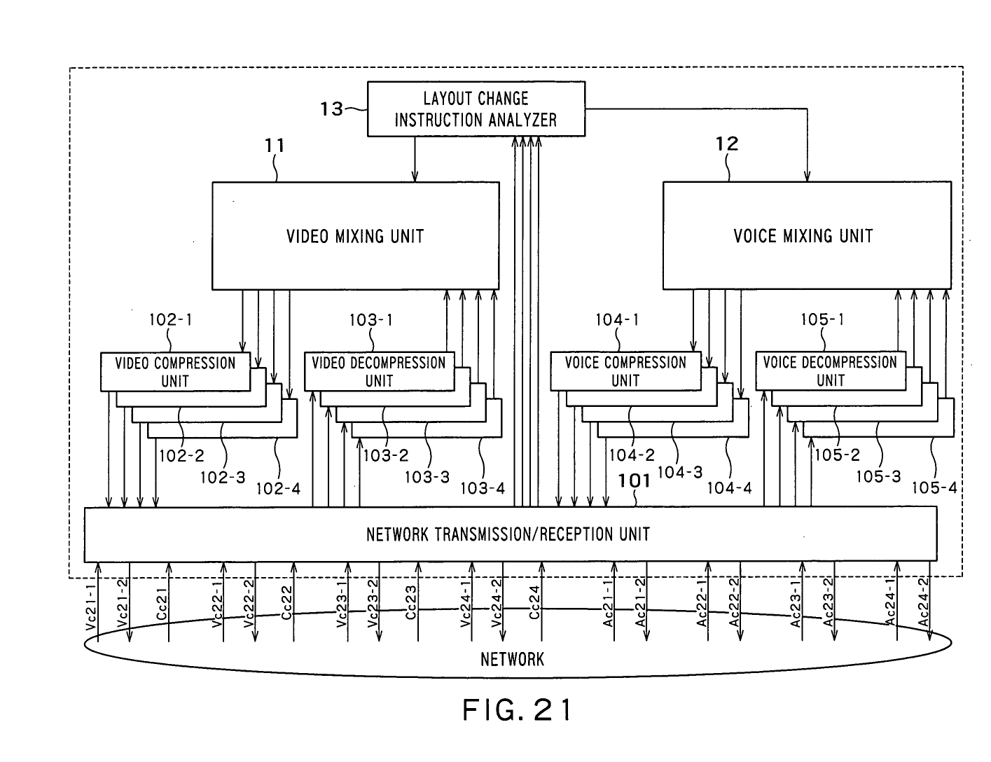

FIG. 21 shows the internal components according to the present invention of the multipoint control unit 1 shown in FIG. 11 and FIG. 12. FIG. 21 omits notations of components which have no direct influence in realizing functional improvements by the present invention or the like (e.g., the CPU).

As the internal components, the multipoint control unit 1 is provided with a network transmission/reception unit 101, four video compression units 102-1 to 102-4, four video decompression units 103-1 to 103-4, four voice compression units 104-1 to 104-4, four voice decompression units 105-1 to 105-4, a video mixing unit 11, a voice mixing unit 12 and a layout change instruction analyzer 13. The above described network transmission/reception unit 101, video compression units 102-1 to 102-4, video decompression units 103-1 to 103-4, voice compression units 104-1 to 104-4, voice decompression units 105-1 to 105-4, video mixing unit 11, voice mixing unit 12 and layout change instruction analyzer 13 are realized by processing routines of the network transmission/reception program, video compression program, video decompression program, voice compression program, voice decompression program, video mixing program, voice mixing program and layout change instruction analysis program shown in FIG. 13 respectively. The network transmission/reception unit 101 corresponds, for example, to the video reception unit, video transmission unit, voice transmission unit, voice reception unit and video selection information receiver.

The network transmission/reception unit 101 can receive video data using the communication channels Vc21-1 to Vc24-1 shown in FIG. 1, transmit video data using the communication channels Vc21-2 to Vc24-2, receive voice data using the communication channels Ac21-1 to Ac24-1, transmit voice data using the communication channels Ac21-2 to Ac24-2 and transmit/receive a layout change parameter when mixing videos using the communication channels Cc21 to Cc24. The network transmission/reception unit 101 transmits/receives video data and voice data using, for example, UDP/IP, RTP as a communication protocol and transmits a parameter when mixing videos using UDP/IP or TCP/IP.

The network transmission/reception unit 101 transmits/receives video data and voice data in a streaming format, manages the start and the end of transmission/reception thereof, can identify video data and voice data to be transmitted/received and transmits/receives video data and voice data using appropriate communication channels.

The network transmission/reception unit 101 outputs the video data received through the Vc21-1 to the video decompression unit 103-1, outputs the video data received through the Vc22-1 to the video decompression unit 103-2, outputs the video data received through the Vc23-1 to the video decompression unit 103-3 and outputs the video data received through the Vc24-1 to the video decompression unit 103-4.

The network transmission/reception unit 101 outputs the voice data received through the Ac21-1 to the voice decompression unit 105-1, outputs the voice data received through the Ac22-1 to the voice decompression unit 105-2, outputs the voice data received through the Ac23-1 to the voice decompression unit 105-3 and outputs the voice data received through the Ac24-1 to the voice decompression unit 105-4.

The non-compressed video data decompressed by the video decompression unit 103-1, video decompression unit 103-2, video decompression unit 103-3 and video decompression unit 103-4 are inputted to video mixing unit 11. The video mixing unit 11 internally creates four kinds of mixed videos MV1 to MV4, outputs the mixed video MV1 to the video compression unit 102-1, outputs the mixed video MV2 to the video compression unit 102-2, outputs the mixed video MV3 to the video compression unit 102-3 and outputs the mixed video MV4 to the video compression unit 102-4.

The non-compressed voice data decompressed by the voice decompression unit 105-1, voice decompression unit 105-2, voice decompression unit 105-3 and voice decompression unit 105-4 are inputted to the voice mixing unit 12. The voice mixing unit 12 internally creates four kinds of mixed voices MA1 to MA4, outputs mixed voice MA1 to the voice compression unit 104-1, outputs mixed voice MA2 to the voice compression unit 104-2, outputs mixed voice MA3 to the voice compression unit 104-3 and outputs mixed voice MA4 to the voice compression unit 104-4.

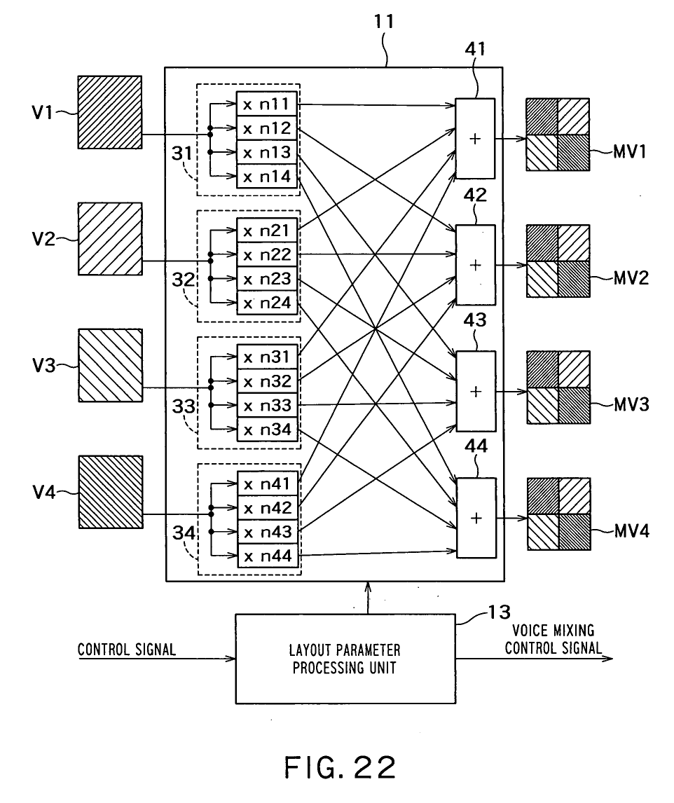

FIG. 22 shows an overview of the internal configuration of the video mixing unit 11 as an example. In the case of FIG. 22, the video mixing unit 11 is provided with reduction circuits 31 to 34 which reduce four input videos to different sizes and mixing circuits 41 to 44 which mix videos reduced by the reduction circuits 31 to 34. The layout change instruction analyzer 13 gives the reduction circuits 31 to 34 their respective reduction parameters and gives the mixing circuits 41 to 44 position parameters which paste reduced videos when generating mixed videos. The input videos for the video mixing unit 11 are the input videos V1 to V4 received from the conference terminals 21 to 24 through the communication channels Vc21-1 to Vc24-1 and converted to the non-compressed video data. When the input videos V1 to V4 are compressed and coded, and transmitted through the communication channels Vc21-1 to Vc24-1, the multipoint control unit 1 uses the received input videos V1 to V4 decompressed and decoded as input videos for the video mixing unit 11. On the other hand, suppose the mixed videos output from the video mixing unit 11 are compressed and coded inside the multipoint control unit 1 and then transmitted through the communication channels vc21-2 to vc24-4. As for reduction parameters (n11, n12, n13, n14, n21, n22, n23, n24, n31, n32, n33, n34, n41, n42, n43, n44) corresponding to the reduction circuits 31 to 34, when, for example, n11=¼, n21=¼, n31=¼, n41=¼ are assumed, it is possible, when generating the mixed video MV1, to instruct that the mixed video MV1 be generated by converting the input videos V1, V2, V3, V4 of 320×240 pixels each to videos of ¼ in an area ratio. Furthermore, the position parameters indicate the positions at which the converted videos are arranged and the mixing circuits 41 to 44 manage mixed videos with XY coordinates which normalize the horizontal direction and vertical direction to values of 100 and when, for example, V1 is specified as X=0, Y=0, V2 as X=0, Y=50, V3 as X=50, Y=0, V4 as X=50, Y=50 for the mixing circuit 41, it is possible to instruct the generation of a mixed video with the respective top left vertices of the input videos V1, V2, V3, V4 for generating the mixed video MV1 output from the reduction circuit 41 arranged at the coordinates points shown above.

The reduction parameters for the reduction circuits 31 to 34 inputted to the video mixing unit 11 from outside and the position parameters for the mixing circuits 41 to 44 are collectively called “video mixing control signals”.

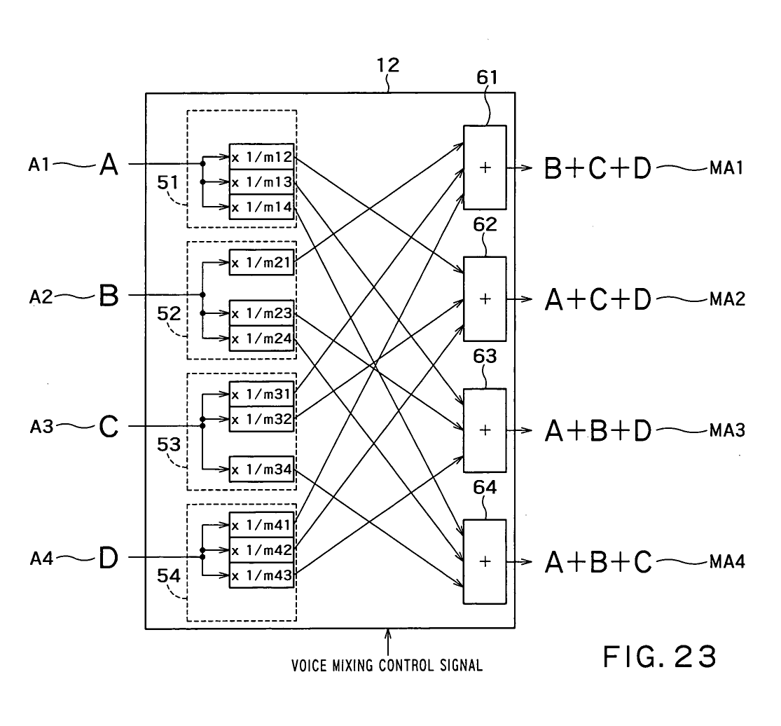

FIG. 23 shows an overview of the internal configuration of the voice mixing unit 12 as an example. In the case of FIG. 23, the voice mixing unit 12 is equipped with adjustment circuits 51 to 54 which adjust average volumes of four input voices and mixing circuits 61 to 64 which mix voices whose average volumes are changed by the adjustment circuits 51 to 54. For parameters (m12, m13, m14, m21, m23, m24, m31, m32, m34, m41, m42, m43) for the adjustment circuits 51 to 54, when, for example, m21=1, m31=1, m41=1 are assumed, the output sound mixed by the mixing circuit 61 is a sound obtained by adding up sounds B, C, D as they are, and on the other hand, when m1=2, m32=½, m42=½ are assumed, the output sound mixed by the mixing circuit 62 is a sound obtained by doubling the sound of A and reducing the sounds volumes of sounds C and D by half and then adding them up.

Parameters for the adjustment circuits 51 to 54 inputted to the voice mixing unit 12 from outside are collectively called “voice mixing control signals”.

The multipoint control unit 1 whose configuration is shown in FIG. 21 can receive a mixed video control packet from each of the conference terminals 21 to 24 through the communication channels Cc21 to Cc24 and the received mixed video control packet is analyzed by the layout change instruction analyzer 13. The layout change instruction analyzer 13 extracts area management table information included in the mixed video control packet received as a layout change parameter. The layout change instruction analyzer 13 generates a video mixing control signal and a voice mixing control signal by analyzing the area management table information, outputs the video mixing control signal generated to the video mixing unit 11 and also outputs the voice mixing control signal generated to the voice mixing unit 12. Processing procedure examples in the layout change instruction analyzer 13 such as the method of generating a video mixing control signal and the method of generating a voice mixing control signal will be explained hereinafter.

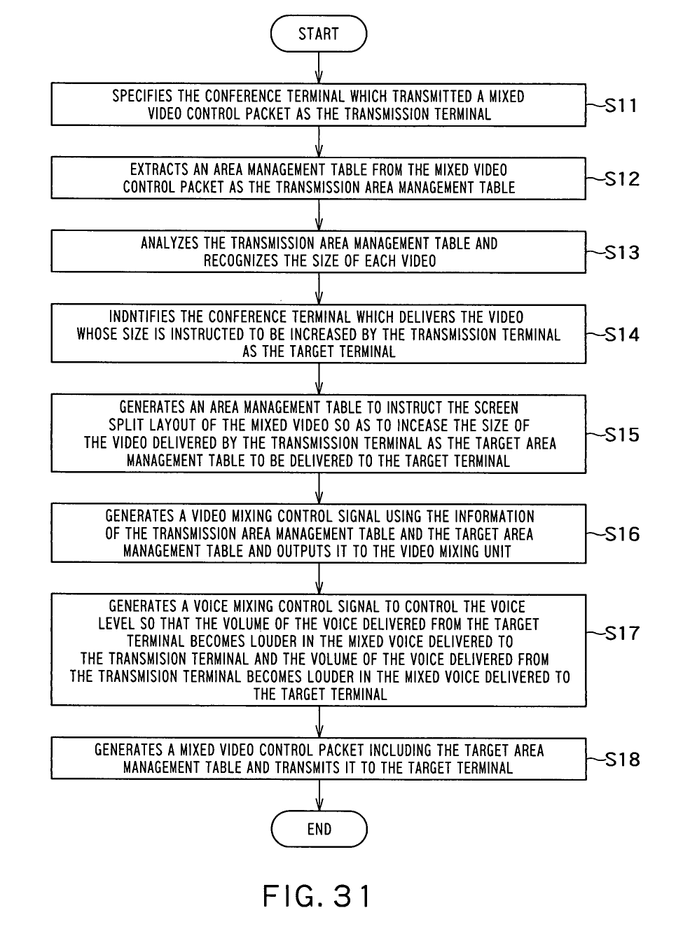

FIG. 31 is a flow chart illustrating the flow of processing procedure example 1.

### [Processing Procedure Example 1]

### (Step 1)

The layout change instruction analyzer 13 judges which conference terminal transmitted a mixed video control packet (S11). The terminal which transmitted the packet is defined as a “transmission terminal”.

### (Step 2)

The layout change instruction analyzer 13 extracts an area management table from the mixed video control packet (S12). This is defined as a “transmission area management table”.

### (Step 3)

The layout change instruction analyzer 13 analyzes the area management table and recognizes how the transmission terminal will change the screen split layout of the mixed video delivered to the transmission terminal (S13). In the case of this embodiment, the size and the arrangement position of each video for generating a mixed video is can be analyzed from the area management table shown in FIG. 16.

### (Step 4)

The layout change instruction analyzer 13 identifies the conference terminal which delivers the video whose size is instructed to be increased by the transmission terminal using the size of each video recognized in step 3 (S14). The conference which delivers this video is defined as a “target terminal”.

### (Step 5)

The layout change instruction analyzer 13 generates a second area management table to instruct the screen split layout of the mixed video to be delivered to the target terminal (S15). This second area management table is defined as a “target area management table”. The target area management table is set so that the size of the video delivered by the transmission terminal increases. For example, the size of the video delivered by the transmission terminal is adjusted so as to be equal to the size of the video delivered by the target terminal specified in the transmission area management table. Furthermore, an arrangement position is specified so that the video whose size is increased falls within the range of the mixed video. Furthermore, the hierarchy information is specified so that the video of the transmission terminal comes to the top layer.

### (Step 6)

The layout change instruction analyzer 13 generates a video mixing control signal using the information of the transmission area management table and the target area management table and outputs it to the video mixing unit (S16).

### (Step 7)

The layout change instruction analyzer 13 generates a voice mixing control signal to control a mixed voice delivered to the transmission terminal and the target terminal and outputs it to the voice mixing unit (S17). In this case, parameters are adjusted so that the volume of the voice delivered from the target terminal becomes louder in the mixed voice delivered to the transmission terminal. Furthermore, parameters are adjusted so that the volume of the voice delivered from the transmission terminal becomes louder in the mixed voice delivered to the target terminal.

### (Step 8)

The layout change instruction analyzer 13 generates a mixed video control packet including the target area management table and transmits it to the target terminal (S18).

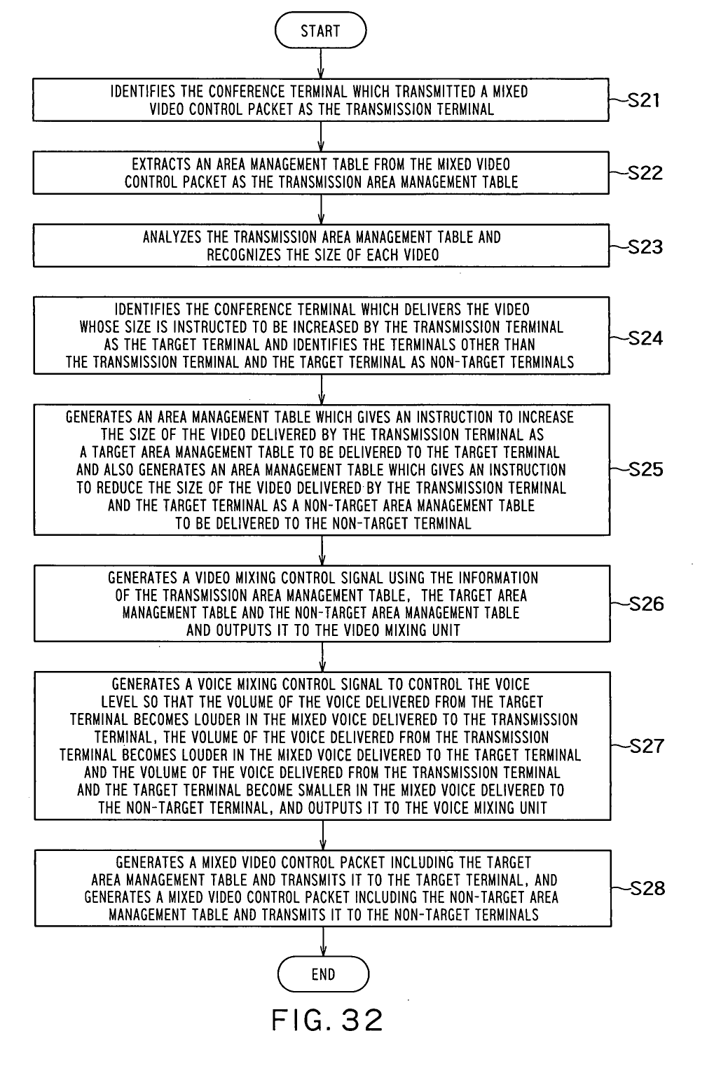

FIG. 32 is a flow chart illustrating the flow of processing procedure example 2.

### [Processing Procedure Example 2]

### (STEP 1)

The layout change instruction analyzer 13 judges which conference terminal transmitted the mixed video control packet (S21). The terminal which transmitted the packet is defined as a “transmission terminal”.

### (Step 2)

The layout change instruction analyzer 13 extracts an area management table from the mixed video control packet (S22). This is defined as a “transmission area management table”.

### (Step 3)

The layout change instruction analyzer 13 analyzes the area management table and recognizes how the transmission terminal will change the screen split layout of the mixed video delivered to the transmission terminal (S23). In the case of this embodiment, the size and the arrangement position of each video for generating a mixed video can be analyzed from the area management table shown in FIG. 16.

### (Step 4)

The layout change instruction analyzer 13 in step 3 (S24). The conference terminal which delivers this video is defined as a “target terminal”. Furthermore, the transmission terminal and terminals other than the target terminal are defined as “non-target terminals”.

### (Step 5)

The layout change instruction analyzer 13 generates a second area management table and a third area management table to instruct a screen split layout of the mixed video delivered to the target terminal and the non-target terminals (S25). This second area management table is defined as a “target area management table” and the third area management table is defined as a “non-target area management table”. The target area management table is set so that the size of the video delivered by the transmission terminal increases. For example, the size of the video delivered by the transmission terminal is adjusted so as to be equal to the size of the video delivered by the target terminal specified in the transmission area management table. Furthermore, the arrangement position is specified so that the video in the increased size falls within the range of the mixed video. Furthermore, the hierarchy information is specified so that the video of the transmission terminal comes to the top layer. On the other hand, the non-target area management table is set so that the size of the video delivered by the transmission terminal and the size of the video delivered by the target terminal become smaller. For example, the sizes of videos delivered by the transmission terminal and the target terminal are adjusted to become the smallest. Furthermore, the arrangement position is specified so that the video in the reduced size falls within the range of the mixed video. Furthermore, the hierarchy information is specified so that the video of the transmission terminal comes to the top layer and the video of the target terminal comes to the second layer.

### (Step 6)

The layout change instruction analyzer 13 generates a video mixing control signal using the information of the transmission area management table and the target area management table and outputs it to the video mixing unit (S26).

### (Step 7)

The layout change instruction analyzer 13 generates a voice mixing control signal to control a mixed voice to be delivered to the transmission terminal and the target terminal and outputs it to the voice mixing unit (S27). In this case, parameters are adjusted so that the volume of the voice delivered from the target terminal becomes louder in the mixed voice delivered to the transmission terminal. Furthermore, parameters are adjusted so that the volume of the voice delivered from the transmission terminal becomes louder in the mixed voice delivered to the target terminal. Furthermore, parameters are adjusted so that the volume of the voice delivered from the transmission terminal and the volume of the voice delivered from the target terminal become smaller in the mixed voice delivered to the non-target terminals.

### (Step 8)

The layout change instruction analyzer 13 generates a mixed video control packet including the target area management table and transmits it to the target terminal (S28). Furthermore, the layout change instruction analyzer 13 generates a mixed video control packet including the non-target area management table and transmits it to the non-target terminals.

As a result of processing procedure example 1 in the above described layout change instruction analyzer 13, when, for example, user A increases the display size of user B (changes from 160×120 pixels to 240×180 pixels) in the mixed video delivered to the own conference terminal 21 as shown in FIG. 6, the video mixing unit 11 of the multipoint control unit 1 can generate a mixed video in which user B is displayed enlarged (changed to 240×180 pixels) in the conference terminal 21, generate a mixed video in which user A is displayed enlarged (changed to 240×180 pixels) in the conference terminal 22 and deliver the respective mixed videos. Furthermore, at the same time, the voice mixing unit 12 of the multipoint control unit 1 can generate a mixed voice in which the voice of user B is increased (the voice of user B is doubled in volume and superimposed) in the conference terminal 21, generate a mixed voice in which the voice of user A is increased (the voice of user A is doubled in volume and superimposed) in the conference terminal 22 and deliver the respective mixed voices.

Furthermore, as a result of processing procedure example 2 in the above described layout change instruction analyzer 13, when, for example, user A increases the display size of user B (changes from 160×120 pixels to 240×180 pixels) in the mixed video delivered to the own conference terminal 21 as shown in FIG. 7, the video mixing unit 11 of the multipoint control unit 1 can generate a mixed video in which user B is displayed enlarged (changed to 240×180 pixels) in the conference terminal 21, generate a mixed video in which user A is displayed enlarged (changed to 240×180 pixels) in the conference terminal 22, generate a mixed video in which user A and user B are displayed miniaturized (changed to 80×60 pixels) in the conference terminal 23 and conference terminal 24 and deliver the respective mixed voices. Furthermore, at the same time, the voice mixing unit 12 of the multipoint control unit 1 can generate a mixed voice in which the voice of user B is increased (the voice of user B is doubled in volume and superimposed) in the conference terminal 21, generate a mixed voice in which the voice of user A is increased (the voice of user A is doubled in volume and superimposed) in the conference terminal 22 and generate a mixed voice in which the voice of user A and user B are reduced (the voices of user A and user B are reduced to ½ in volume and superimposed) in the conference terminal 23 and conference terminal 24 and deliver the respective mixed voices.

This embodiment has explained the case where the number of conference terminals is four, but the number of terminals is not limited to this and the number of terminals may also be more or less than four. When there are many conference terminals, such a case can be handled by increasing the number of corresponding components in the multipoint control unit 1.

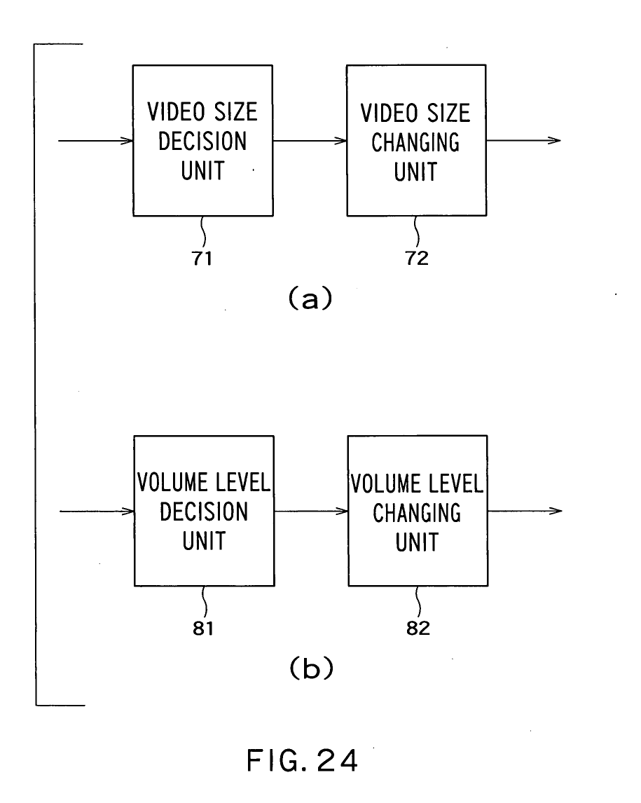

This embodiment has explained the case where the sizes of all videos transmitted from the conference terminals 21 to 24 are 320×240 pixels, but the sizes of videos transmitted from the respective conference terminals may also differ from one another. In such a case, it is possible to input videos, for example, to a video size decision unit 71 as shown in FIG. 24(a) before inputting the videos to the video mixing unit 11 of the multipoint control unit 1, examine the sizes of the videos, further input the videos to a video size changing unit 72 and change their sizes to 320×240 pixels so as to obtain the videos in the same size.

This embodiment assumes that the average volumes of voices transmitted from the conference terminals 21 to 24 are the same, but the average volumes of voices transmitted from the respective conference terminals may also differ from one another. In such a case, it is possible to input voices, for example, to a volume level decision unit 81 as shown in FIG. 24(b) before inputting the voices to the voice mixing unit 12 of the multipoint control unit 1, examine the average volume of the voices, further input the voices to a volume level changing unit 82 and set the average volume to a specified value so as to obtain the voices of the same average volume.

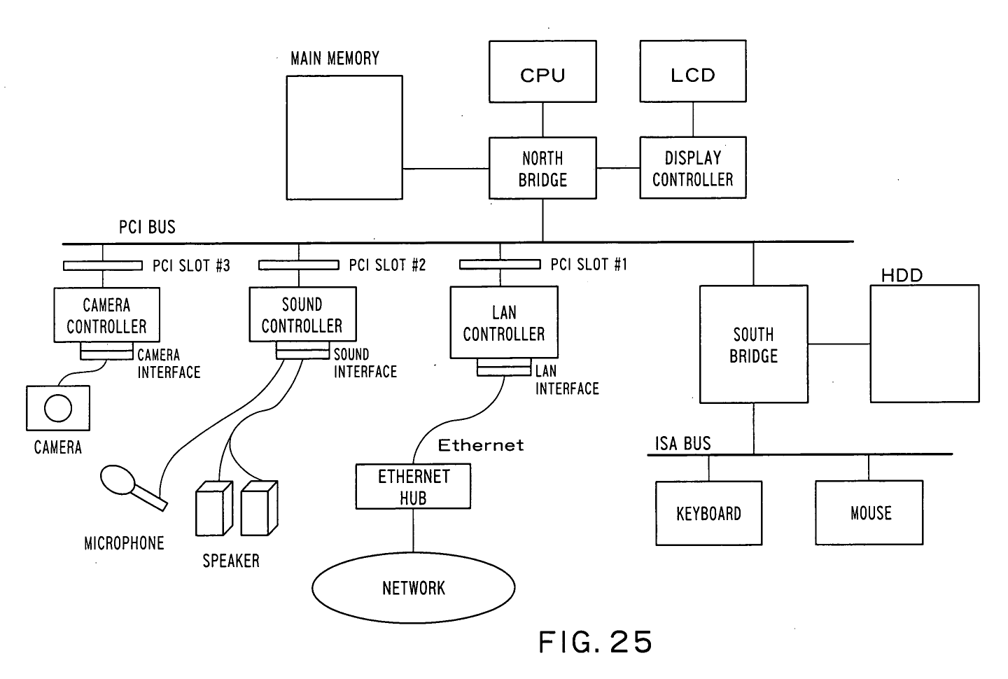

Furthermore, FIG. 25 shows a system configuration example of the conference terminal 21 which is different from that in FIG. 9. In the example of FIG. 25, the north bridge and south bridge are connected via a PCI bus and a camera controller, a sound controller and a LAN controller are connected to the PCI bus. The camera controller is controlled by a video acquisition program, the sound controller is controlled by a voice acquisition program and a voice reproducing program and the LAN controller is controlled by a network transmission/reception program and the system thereby operates in the same way as the system in FIG. 9.

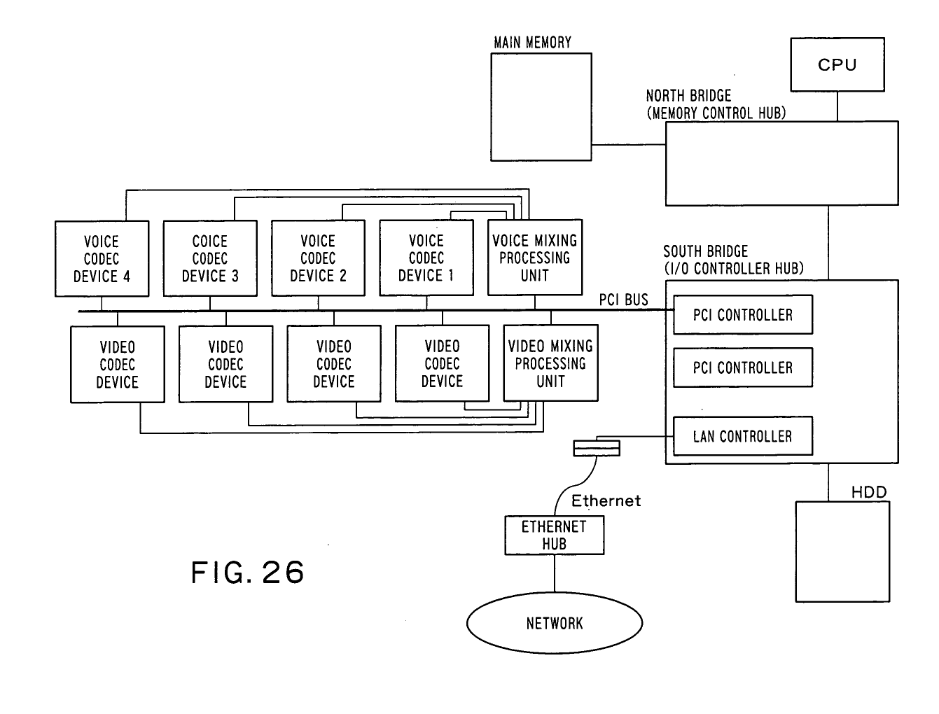

Furthermore, FIG. 26 shows a system configuration example of the multipoint control unit 11 which is different from that in FIG. 12. In the example in FIG. 26, the south bridge is equipped with a PCI controller and four video CODEC devices, four voice CODEC devices, one video mixing device and one voice mixing device are connected to the PCI bus which is controlled by a PCI controller. The video CODEC device is designed to realize part of the processing of the above described video compression program and video decompression program by hardware, and can decrease the processing load on the CPU compared to the case where the video compression program and the video decompression program perform all processing by software and also perform all processing at a higher speed through hardware processing. The voice CODEC device is designed to realize part of the processing of the above described voice compression program and voice decompression program by hardware, and can decrease the processing load on the CPU compared to the case where the voice compression program and the voice decompression program perform all processing by software and also perform all processing at a higher speed through hardware processing. Furthermore, the video mixing device is designed to realize part of the processing of the above described video mixing program by hardware, and can decrease the processing load on the CPU compared to the case where the video mixing program performs all processing by software and also perform processing at a higher speed through hardware processing. Furthermore, the voice mixing device is designed to realize part of the processing of the above described voice mixing program by hardware, and can decrease the processing load on the CPU compared to the case where the voice mixing program performs all processing by software and also perform processing at a higher speed through hardware processing.

As the first embodiment of the present invention, the detailed configurations and operations of the multipoint control unit 1 and conference terminals 21 to 24 and the video-conferencing system made up of these components have been shown so far.

At an actual conference, local conversations (private conversations) such as private consultation and confirmation are often conducted. When a local conversation is held during an actual conference, an interested party often talks to the other party in such a small voice that other conferees cannot hear. That is, the party approaches the other party and talks in a suppressed tone of voice.

For example, a certain user A performs control so that in a mixed video delivered to the own device, the facial image of a user B with whom the user A wants to conduct a local conversation among other parties of communication displayed in the mixed video is displayed enlarged and a virtual sense of distance from the user B is thereby shortened. In this case, control is automatically performed so that the face of the user A is also displayed enlarged on the user B side and a virtual sense of distance from the user A is thereby shortened for the user B, too. In this condition, only the voice of the user A out of the mixed voices delivered to the user B is emphasized and mixed and only the voice of the user B out of the mixed voice delivered to the user A is emphasized and mixed. That is, after shortening the sense of distance, even if the user A and the user B conduct a conversation in a smaller voice than normal voice, the conversation between the parties becomes easy to be heard as a result of the emphasis. On the other hand, other users can hear the conversation between the user A and the user B just as the same small voice. The present invention allows users to conduct a local conversation even during a video-conference in a sense similar to that in an actual conference.

Here, in the above described example of FIG. 6, the face of the user B is displayed enlarged in the conference terminal 21 and the voice of the user B out of the mixed voices delivered to the conference terminal 21 (user A) is emphasized, but control may also be performed such that only the voice of the user B is emphasized without changing the size of the face of the user B. For the conference terminal 22 (user B), control may also be performed such that only the voice of the user A is emphasized without changing the size of the face of the user A.

Furthermore, in the example of FIG. 7, the voice of the user B in the mixed voice delivered to the user A and the voice of the user A in the mixed voice delivered to the user B are emphasized while the voices of the users A, B in the mixed voice delivered to the user C and the voices of the users A, B in the mixed voice delivered to the user D are suppressed. However, it is also possible to perform control so as to suppress the voices of the users A, B in the mixed voice delivered to the user C and the voices of the users A, B in the mixed voice delivered to the user D without changing the voice level of the user B in the mixed voice delivered to the user A and the voice level of the user A in the mixed voice delivered to the user B.

This embodiment has described the “rectangular frame change processing” as a specific example of the operation method of increasing the display of the facial image of the other party with whom a user wants to conduct a local conversation in a mixed video displayed on the conference terminal side, but the operation method is not limited to this. For example, as an operation to select the other party, when the mouse button is “clicked” on the facial image of the other party with whom the user wants to conduct a local conversation, it is possible to send position information indicating the clicked point in the mixed video from the conference terminal to the multipoint control unit, detect the parties who conduct a local conversation from the information on the multipoint control unit side, generate a mixed video with the sizes of the respective facial images adjusted for the parties and deliver the mixed video or generate a mixed voice with the volumes of the respective voices adjusted and deliver the mixed voice. It is also possible to perform control such that left clicking causes the sizes of the facial images or the sound volumes of the parties to double or become a maximum and right clicking causes the sizes of the facial images or the sound volumes which have been increased by left clicking to be reduced to ½ or return to their original levels.

Moreover, this embodiment generates and delivers a mixed video in which facial images of parties who conduct a local conversation are displayed enlarged, but the operation of selecting the other party need not be limited to the method of enlarging the facial image of the party. For example, it is possible to generate and deliver a mixed video in which the facial image of the party is displayed framed or generate and deliver a mixed video in which the facial images of users other than the party are displayed with lowered color tones and darkened so that only the party is highlighted.

### Second Embodiment

Hereinafter, a second embodiment of the present invention will be presented with reference to drawings.

The configurations of conference terminals 21 to 24 and a multipoint control unit 1 of this embodiment are the same as those of the first embodiment and correspond to the first embodiment with the function of a layout change instruction analyzer 13 added thereto.

FIG. 7 is an example of an operation result when the present invention explained in the first embodiment is mounted in the conference terminals 21 to 24 and the multipoint control unit 1 and shows a result of operation that the layout change instruction analyzer 13 of the multipoint control unit 1 analyses a layout change parameter of a mixed video received from the conference terminal 21 and a video mixing unit 11 and a voice mixing unit 12 operate according to the analysis result of the layout change instruction analyzer 13. When a user A performs change processing such that the facial image of a user B is displayed enlarged in a mixed video delivered to the own conference terminal 21, the video mixing unit 11 generates a mixed video in which the user B is displayed enlarged (changed, for example, to 240×180 pixels) in the conference terminal 21 according to the analysis result of the layout change instruction analyzer 13 of the multipoint control unit 1, generates a mixed video in which the user A is displayed enlarged (changed, for example, to 240×180 pixels) in the conference terminal 22, generates a mixed video in which the user A and the user B are displayed miniaturized (changed to 80×60 pixels) in the conference terminal 23 and conference terminal 24 and delivers the respective mixed videos. In addition, the voice mixing unit 12 of the multipoint control unit 1 generates a mixed voice in which the voice of the user B is made loud (the voice of the user B is doubled in volume and superimposed) in the conference terminal 21, generates a mixed voice in which the voice of the user A is made loud (the voice of the user A is doubled in volume and superimposed) in the conference terminal 22 and generates a mixed voice in which the voices of the user A and the user B are suppressed (the voices of the user A and the user B are reduced to ½ in volume and superimposed) in the conference terminal 23 and conference terminal 24 and delivers the respective mixed voices.

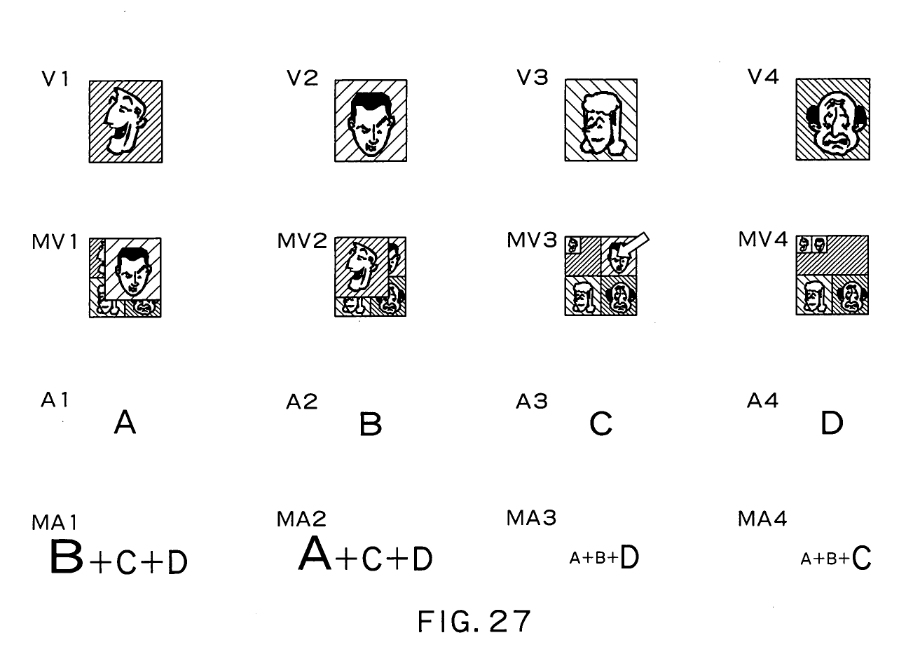

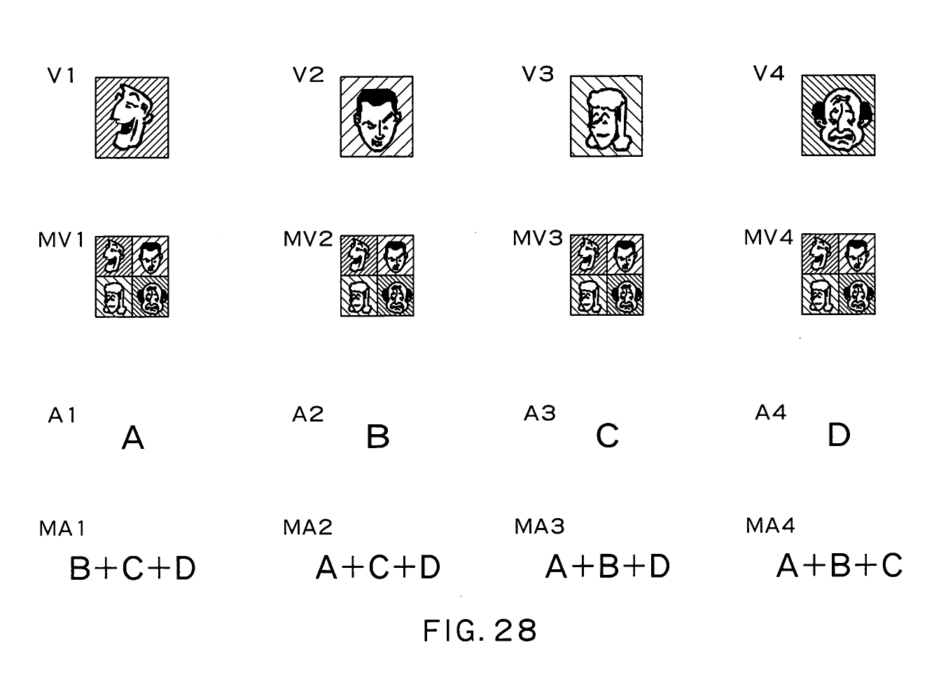

FIG. 27 shows a situation in which in the condition of FIG. 7, a user C of the conference terminal 23 sees the layout of the mixed video delivered to himself/herself, recognizes that “the user A and the user B are holding a local conversation” since the user A and the user B are displayed miniaturized and then performs an operation to increase the display size of the user B and receives a mixed video in which the user B is displayed enlarged from the multipoint control unit 1.

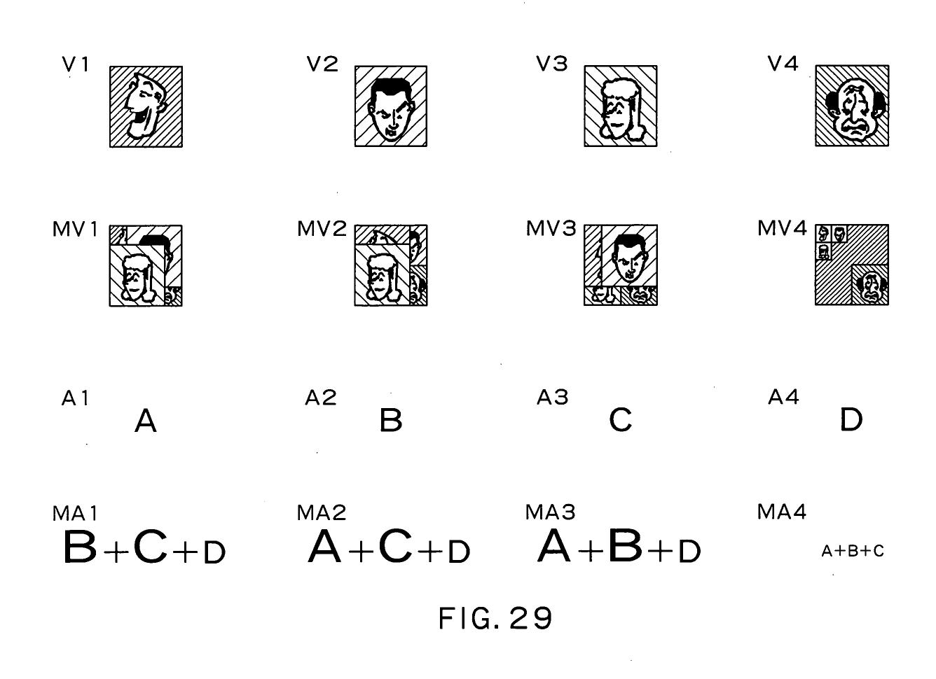

FIG. 28 shows a first example which shows a condition immediately after FIG. 27. As a result of receiving the layout change parameter from the conference terminal 23, the layout change instruction analyzer 13 judges that the user C is requesting that the local conversation between the user A and the user B should be stopped, generates mixed videos (MV1 to MV4) and mixed voices (MA1 to MA4) so as to restore the first condition shown in FIG. 3 in which the four users started the video-conferencing system and delivers the respective mixed videos and mixed voices to the conference terminals 21 to 24.

On the other hand, FIG. 29 is a second example which shows a condition immediately after FIG. 27. As a result of receiving the layout change parameter from the conference terminal 23, the layout change instruction analyzer 13 judges that the user C is requesting to participate in the local conversation between the user A and the user B. According to the instruction from the layout change instruction analyzer 13 of the multipoint control unit 1, the video mixing unit 11 generates a mixed video in which the user B and the user C are displayed enlarged (changed to 240×180 pixels) in the conference terminal 21, generates a mixed video in which the user A and the user C are displayed enlarged (changed to 240×180 pixels) in the conference terminal 22, generates a mixed video in which the user A and the user B are displayed enlarged (changed to 240×180 pixels) in the conference terminal 23, generates a mixed video in which the user A, the user B and the user C are displayed miniaturized (changed to 80×60 pixels) in the conference terminal 24 and delivers the respective mixed videos. In addition, according to the instruction from the layout change instruction analyzer 13 of the multipoint control unit 1, the voice mixing unit 12 generates a mixed voice in which the voices of the user B and the user C are made loud (the voices of the user B and the user C are doubled in volume and superimposed) in the conference terminal 21, generates a mixed voice in which the voices of the user A and the user C are made loud (the voices of the user A and the user C are doubled in volume and superimposed) in the conference terminal 22, generates a mixed voice in which the voices of the user A and the user B are made loud (the voices of the user A and the user B are doubled in volume and superimposed) in the conference terminal 23 and generates a mixed voice in which the voices of the user A, the user B and the user C are suppressed (the voices of the user A, the user B and the user C are reduced to ½ in volume and superimposed) in the conference terminal 24 and delivers the respective mixed voices.

In an actual conference, local conversations (private conversations) such as private consultation and confirmation are often conducted during the conference. In an actual conference, while engaging a local conversation, a party concerned often holds a conversation in a small voice with the other party so that other people in the conference do not hear the voice. That is, the parties come close to each other and talk in suppressed tone of voice. The present invention allows the other conferees to recognize that a local conversation is being held, cause the local conversation to stop or also participate in the local conversation depending on their needs.

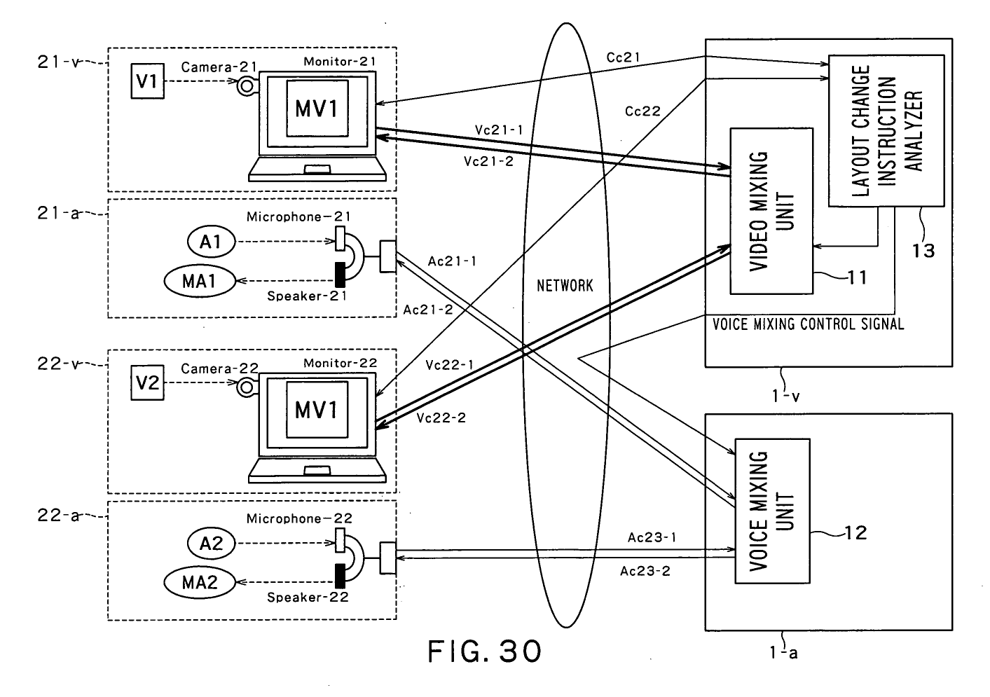

FIG. 30 shows an example using a multipoint control unit 1-v for a video communication which includes no voice mixing function and a multipoint control unit 1-a for a voice communication which includes no video mixing function instead of the multipoint control unit 1 shown in FIG. 1. Both the multipoint control unit 1-v for a video communication and the multipoint control unit 1-a for a voice communication include the components of the present invention. In FIG. 30, a voice mixing control signal generated at a layout change instruction analyzer 13 of the multipoint control unit 1-v for a video communication is inputted to a voice mixing unit 12 in the multipoint control unit 1-a for a voice communication through a network. The present invention is also applicable to such a configuration and can obtain effects similar to those explained in the first embodiment and the second embodiment.

What is claimed is:

1. A video mixer comprising:
a video reception unit configured to receive first to third video data expressing first to third videos from first to third terminals;
a video mixing unit configured to mix the first to third video data to generate first to third mixed video data expressing first to third mixed videos;
a video transmission unit configured to transmit the first to third mixed video data to the first to third terminals;
a voice reception unit configured to receive first to third voice data expressing first to third voices from the first to third terminals;
a voice mixing unit configured to mix the first to third voice data to generate first to third mixed voice data expressing first to third mixed voices;
a voice transmission unit configured to transmit the first to third mixed voice data to the first to third terminals;
a video selection information receiver configured to receive video selection information indicating that the second video is selected from the first terminal; and
a voice control unit configured to generate a voice mixing control signal which gives an instruction to increase a voice level of the second voice to be included in the first mixed voice and a voice level of the first voice to be included in the second mixed voice and give the voice mixing control signal to the voice mixing unit.

2. The video mixer according to claim 1, wherein the voice control unit generates the voice mixing control signal which further gives an instruction to reduce a voice level of a third voice to be included in the first and second mixed voices.

3. The video mixer according to claim 1, wherein the voice control unit generates the voice mixing control signal which further gives an instruction to reduce the voice levels of the first and second voices to be included in the third mixed voice.

4. The video mixer according to claim 1, further comprising a video control unit configured to generate a video mixing control signal which gives an instruction to increase a size of the second video to be included in the first mixed video and a size of the first video to be included in the second mixed video and give the video mixing control signal to the video mixing unit.

5. The video mixer according to claim 4, wherein the video control unit generates the video mixing control signal which further gives an instruction to reduce a size of the third video to be included in the first mixed video and the size of the third video to be included in the second mixed video.

6. The video mixer according to claim 1, further comprising a video control unit configured to generate a video mixing control signal which gives an instruction to miniaturize a size of the third video to be included in the first mixed video and a size of the third video to be included in the second mixed video and give the video mixing control signal to the video mixing unit.

7. The video mixer according to claim 1, further comprising a video control unit configured to generate a video mixing control signal which gives an instruction to miniaturize a size of the first and second videos to be included in the third mixed video and give the video mixing control signal to the video mixing unit.

8. The video mixer according to claim 7, wherein the video selection information receiver receives video selection information indicating that the first or second video has been selected from the third terminal,
the video control unit generates a video mixing control signal which gives an instruction to return the sizes of the first and the second videos to be included in the third mixed video to their original sizes, and
the voice control unit generates a voice mixing control signal which gives an instruction to return the voice level of the second voice to be included in the first mixed voice and the voice level of the first voice to be included in the second mixed voice to their original voice levels.

9. The video mixer according to claim 7, wherein the video selection information receiver receives video selection information indicating that the first or the second video has been selected from the third terminal, and
the voice control unit generates a voice mixing control signal which gives an instruction to increase the voice level of the third voice to be included in the first mixed voice, the voice level of the third voice to be included in the second mixed voice and the voice levels of the first and the second voice to be included in the third mixed voice.

10. The video mixer according to claim 1, wherein the video selection information by the video selection information receiver gives an instruction to increase the size of the second video to be included in the first mixed video.

11. A video mixer comprising:
a video reception unit configured to receive first to third video data expressing first to third videos from first to third terminals;
a video mixing unit configured to mix the first to third video data to generate first to third mixed video data expressing first to third mixed videos;
a video transmission unit configured to transmit the first to third mixed video data to the first to third terminals;
a voice reception unit configured to receive first to third voice data expressing first to third voices from the first to third terminals;
a voice mixing unit configured to mix the first to third voice data to generate first to third mixed voice data expressing first to third mixed voices;
a voice transmission unit configured to transmit the first to third mixed voice data to the first to third terminals;
a video selection information receiver configured to receive video selection information indicating that the second video has been selected from the first terminal; and
a mixed voice control unit configured to generate a voice mixing control signal which gives an instruction to reduce the voice levels of the first voice and the second voice to be included in the third mixed voice and give the voice mixing control signal to the voice mixing unit.

12. A video mixer comprising:
a video reception unit configured to receive first to third video data expressing first to third videos from first to third terminals;
a video mixing unit configured to mix the first to third video data to generate first to third mixed video data expressing first to third mixed videos;
a video transmission unit configured to transmit the first to third mixed video data to the first to third terminals;
a voice reception unit configured to receive first to third voice data expressing first to third voices from the first to third terminals;
a voice mixing unit configured to mix the first to third voice data to generate first to third mixed voice data expressing first to third mixed voices;
a voice transmission unit configured to transmit the first to third mixed voice data to the first to third terminals;
a video selection information receiver configured to receive video selection information indicating that the second video has been selected from the first terminal; and
a mixed voice control unit configured to generate a voice mixing control signal which gives an instruction to reduce the voice level of the third voice to be included in the first mixed voice and the second mixed voice and give the voice mixing control signal to the voice mixing unit.

13. A video mixing method comprising:
receiving first to third video data expressing first to third videos from first to third terminals;
mixing the first to third video data to generate first to third mixed video data expressing first to third mixed videos;
transmitting the first to third mixed video data to the first to third terminals;
receiving first to third voice data expressing first to third voices from the first to third terminals;
mixing the first to third voice data to generate first to third mixed voice data expressing first to third mixed voices;
transmitting the first to third mixed voice data to the first to third terminals; and
increasing a voice level of the second voice to be included in the first mixed voice and a voice level of the first voice to be included in the second mixed voice upon receiving video selection information indicating that the second video has been selected from the first terminal.

14. A computer readable medium storing a computer program for causing a computer to execute instructions to perform steps of:
receiving first to third video data expressing first to third videos from first to third terminals;
mixing the first to third video data to generate first to third mixed video data expressing first to third mixed videos;
transmitting the first to third mixed video data to the first to third terminals;
receiving first to third voice data expressing first to third voices from the first to third terminals;
mixing the first to third voice data to generate first to third mixed voice data expressing first to third mixed voices;
transmitting the first to third mixed voice data to the first to third terminals;
receiving video selection information indicating that the second video has been selected from the first terminal; and
controlling voice mixing so as to increase a voice level of the second voice to be included in the first mixed voice and a voice level of the first voice to be included in the second mixed voice.

15. A video mixer which can communicate with a voice mixer configured to mix first to third voice data expressing first to third voices transmitted from first to third terminals, generate first to third mixed voice data expressing first to third mixed voices and transmit the first to third mixed voice data generated to the first to third terminals, comprising:
a video reception unit configured to receive first to third video data expressing first to third videos from the first to third terminals;
a video mixing unit configured to mix the first to third video data to generate first to third mixed video data expressing first to third mixed videos;
a video transmission unit configured to transmit the first to third mixed video data to the first to third terminals;
a video selection information receiver configured to receive video selection information indicating that the second video has been selected from the first terminal; and
a voice control unit configured to generate a voice mixing control signal which gives an instruction to increase a voice level of the second voice to be included in the first mixed voice and a voice level of the first voice to be included in the second mixed voice and transmit the voice mixing control signal generated to the voice mixing unit.
